(19) United States
(12) Patent Application Publication
(10) Pub. No.: US 2025/0142291 A1
(43) Pub. Date: May 1, 2025

(54) MEASUREMENT AND REPORTING FOR ARTIFICIAL INTELLIGENCE BASED POSITIONING

(71) Applicant: LENOVO (SINGAPORE) PTE. LTD., Singapore (SG)

(72) Inventors: Robin Rajan Thomas, Frankfurt (DE); Ankit Bhamri, Rödermark (DE)

(73) Assignee: LENOVO (SINGAPORE) PTE. LTD., Singapore (SG)

(21) Appl. No.: 18/835,625

(22) PCT Filed: Feb. 3, 2023
(86) PCT No.: PCT/IB2023/050936

§ 371 Date: Aug. 2, 2024

Related U.S. Application Data
(60) Provisional application No. 63/306,777, filed on Feb. 4, 2022.

(51) Int. Cl. H04W 4/029; H04L 27/26; H04W 24/02

(52) U.S. Cl. CPC H04W 4/029; H04L 27/261; H04W 24/02

(57) ABSTRACT

Various aspects of the present disclosure relate to a device that receives a request by a location server to query for positioning measurements which are labelled or unlabelled, which is dependent on whether a supervised or unsupervised learning model is used. The requested positioning measurements, each associated with a label, are provided to a training system that trains one or more artificial intelligence (AI) inference models. The one or more AI inference models are deployed to a location management function (LMF), which makes predictions based on subsequent positioning measurements received from the device.

### RELATED APPLICATION

This application claims priority to U.S. Patent Application Ser. No. 63/306,777 filed Feb. 4, 2022 entitled “Measurement and Reporting for Artificial Intelligence Based Positioning,” the disclosure of which is incorporated by reference herein in its entirety.

### TECHNICAL FIELD

The present disclosure relates to wireless communications, and more specifically to measurement and reporting for artificial intelligence (AI) based positioning.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system, such as time resources (e.g., symbols, slots, subslots, mini-slots, aggregated slots, subframes, frames, or the like) or frequency resources (e.g., subcarriers, carriers). Additionally, the wireless communications system may support wireless communications across various radio access technologies (RATs) including third generation (3G) RAT, fourth generation (4G) RAT, fifth generation (SG) RAT, and other suitable RATs beyond 5G. In some cases, a wireless communications system may be a non-terrestrial network (NTN), which may support various communication devices for wireless communications in the NTN. For example, an NTN may include network entities onboard non-terrestrial vehicles such as satellites, unmanned aerial vehicles (UAV), and high-altitude platforms systems (HAPS), as well as network entities on the ground, such as gateway entities capable of transmitting and receiving over long distances.

In a wireless communication system devices oftentimes use the position or location of another device, such as a location server performing various operations based on the position or location of a UE. The location server sends, to the UE, a message requesting positioning measurements or a position estimate from the UE. The UE responds to the location server with a location information message including the positioning measurements or a position estimate for the UE. Various different positioning methods can be used to obtain the positioning measurements or a position estimate, such as assisted global navigation satellite system (A-GNSS), motion sensor positioning, downlink time difference of arrival (DL-TDOA), downlink angle-of-departure (DL-AoD), and so forth.

### SUMMARY

The present disclosure relates to methods, apparatuses, and systems that support measurement and reporting for AI based positioning. Reporting of measurements is enhanced by enabling a request indication by a location server to query for positioning measurements which are labelled or unlabelled, which is dependent on whether a supervised or unsupervised learning model is used. In one or more implementations, the location server trains and deploys the AI inference models with the aid of positioning measurement data received by the UEs or base stations. Additionally or alternatively, the AI inference models are trained at the UE and the base station, and then deployed at the location server. By utilizing the described techniques, various classification algorithms (e.g., AI inference models) can be readily trained to predict different metrics in time and space (e.g., positioning reference signals (PRS) or sounding reference signal (SRS) configuration, final location accuracy).

Some implementations of the method and apparatuses described herein may include wireless communication at a device (e.g., at a UE or a base station), which includes receiving, from a location server, a request message to output labelled positioning measurements to an AI training system; collecting a set of positioning measurements based at least in part on the received request message; labelling the collected set of positioning measurements by associating each of one or more positioning measurements of the collected set of positioning measurements with a line-of-sight (LOS) path, a non-line-of-sight (NLOS) path, UE location information, a number of detected paths, or a combination thereof; and outputting a response message comprising the labelled set of positioning measurements to the AI training system based at least in part on the received request message from the location server, the response message indicating deployment and training of an AI inference model using the labelled set of positioning measurements.

In some implementations of the method and apparatuses described herein, to label the collected set of positioning measurements, the processor and the transceiver are configured to cause the apparatus to: label the collected set of positioning measurements by associating each of one or more positioning measurements of the collected set of positioning measurements with a polarization type, coherence bandwidth information, a channel frequency response, or a Ricean factor, or a combination thereof. Additionally or alternatively, to output the labelled set of positioning measurements, the processor and the transceiver are configured to cause the apparatus to: transmit, to the location server, the response message comprising the labelled set of positioning measurements, the location server comprising the AI training system, wherein the response message comprising an indication signaling to the location server to deploy the AI inference model at the location server. Additionally or alternatively, to output the labelled set of positioning measurements, the processor and the transceiver are configured to cause the apparatus to: output the labelled set of positioning measurements to the AI training system at the apparatus; enable the AI training system to train the AI inference model; and transmit the trained AI inference model to the location server. Additionally or alternatively, the set of positioning measurements includes positioning measurements obtained using downlink (DL)-based positioning techniques including one or more of DL-TDOA, DL-AoD, downlink enhanced cell-ID (DL-E-CID), UL-based positioning techniques including one or more of uplink relative time of arrival (UL-RTOA), uplink angle-of-arrival (UL-AoA), uplink enhanced cell-ID (UL-E-CID), or both uplink (UL) and DL-based positioning techniques including multicell round trip time (Multi-RTT). Additionally or alternatively, to label the collected set of positioning measurements, the processor and the transceiver are configured to cause the apparatus to: add labels to the positioning measurements according to downlink positioning reference signals (DL-PRS) and SRS resource granularities comprising positioning frequency layers, bandwidth parts, resource set, resources, transmission-reception points (TRPs) or combinations thereof. Additionally or alternatively, the apparatus is to receive, from the location server, a request via new radio positioning protocol annex (NRPPa) signalling for an updated DL-PRS configuration based on the AI inference model deployed at the location server. Additionally or alternatively, the apparatus is to receive, from the location server, a request via NRPPa signalling for an updated SRS configuration based on the AI inference model deployed at the location server. Additionally or alternatively, the apparatus is to receive, from the location server via long-term evolution positioning protocol (LPP) signalling, an updated DL-PRS configuration based on the AI inference model deployed at the location server. Additionally or alternatively, the apparatus is to: receive, from the location server, activation messaging via NRPPa; and activate, in response to the activation messaging, an updated SRS configuration received via medium access control (MAC) control element (CE) based on the AI inference model deployed at the location server. Additionally or alternatively, the AI training system uses model training criteria including a defined area and time duration for which the AI inference model is valid. Additionally or alternatively, the apparatus is to transfer the AI inference model, trained by the AI training system at the apparatus, to the location server via LPP and NRPPa signalling. Additionally or alternatively, the apparatus comprises a UE or a base station.

Some implementations of the method and apparatuses described herein may include wireless communication at a device (e.g., at a UE or a base station), which includes transmitting, to a target device, a request message to output labelled positioning measurements to an AI training system, wherein the labelling of positioning measurements includes collecting a set of positioning measurements and labelling the collected set of positioning measurements by associating each of one or more positioning measurements of the collected set of positioning measurements with at least one of an LOS path, an NLOS path, UE location information, a number of detected paths, or a combination thereof, receiving, from the AI training system, an AI inference model that was trained using the labelled set of positioning measurements; deploying, at the apparatus, the AI inference model that was trained using the labelled set of positioning measurements; and applying the AI inference model to predict radio environment characteristics and corresponding positioning quality of service (Qos) of the target device.

In some implementations of the method and apparatuses described herein, to predict the radio environment characteristics and corresponding positioning QoS, the processor and the transceiver are configured to cause the apparatus to predict the radio environment characteristics and corresponding positioning QoS for one or more of a future time interval, a time window, or a single time instance. Additionally or alternatively, the processor and the transceiver are configured to cause the apparatus to predict the radio environment characteristics and corresponding positioning QoS for one or more of a future area, region, or a geographical zone. Additionally or alternatively, the radio environment characteristics include one or more of LOS or NLOS radio propagation links, multipath links, interference sources, reference signal received power (RSRP), signal to noise ratio (SNR), and signal to interference noise ratio (SINR). Additionally or alternatively, to predict the radio environment characteristics and corresponding positioning QoS, the processor and the transceiver are configured to cause the apparatus to predict the radio environment characteristics and corresponding positioning QoS for one or more of a future area, region, or a geographical zone. Additionally or alternatively, the positioning QoS includes one or more of absolute and relative positioning accuracy, orientation accuracy, velocity estimates, confidence intervals, integrity, or reliability. Additionally or alternatively, the apparatus is to request to transfer and deploy the AI inference model trained at the target device based on model training criteria.

### BRIEF DESCRIPTION OF THE DRAWINGS

Various aspects of the present disclosure for measurement and reporting for artificial intelligence based positioning are described with reference to the following Figures. The same numbers may be used throughout to reference like features and components shown in the Figures.

FIG. 1 illustrates an example of a wireless communications system that supports measurement and reporting for artificial intelligence based positioning in accordance with aspects of the present disclosure.

FIG. 2 illustrates an example of absolute and relative positioning scenarios as related to measurement and reporting for artificial intelligence based positioning in accordance with aspects of the present disclosure.

FIG. 3 illustrates an example of a multi-cell RTT procedure as related to measurement and reporting for artificial intelligence based positioning in accordance with aspects of the present disclosure.

FIG. 4 illustrates an example of a system for existing relative range estimation as related to measurement and reporting for artificial intelligence based positioning in accordance with aspects of the present disclosure.

FIG. 5 illustrates an example of a system of NR beam-based positioning as related to measurement and reporting for artificial intelligence based positioning in accordance with aspects of the present disclosure.

FIG. 6 illustrates an example of a LPP request location information message as related to measurement and reporting for artificial intelligence based positioning, as described herein.

FIG. 7 illustrates an example of a LPP provide location information message as related to measurement and reporting for artificial intelligence based positioning, as described herein.

FIG. 8 illustrates an example training system for training an AI inference model.

FIG. 9 illustrates an example procedure of the message exchange between a UE and an LMF.

FIG. 10 illustrates an example procedure to support the data collection for both training and inference located in the LMF.

FIGS. 11a and 11b illustrate an example procedure to support the data collection for distributed training of AI inference models.

FIG. 12 illustrates an example of a block diagram of a device that supports measurement and reporting for artificial intelligence based positioning in accordance with aspects of the present disclosure.

FIG. 13 illustrates an example of a block diagram of a device that supports measurement and reporting for artificial intelligence based positioning in accordance with aspects of the present disclosure.

FIGS. 14, 15, and 16 illustrate flowcharts of methods that support measurement and reporting for artificial intelligence based positioning in accordance with aspects of the present disclosure.

### DETAILED DESCRIPTION

Implementations of measurement and reporting for artificial intelligence based positioning are described, such as related to methods, apparatuses, and systems that support measurement and reporting for AI based positioning. Reporting of measurements is enhanced by enabling a request indication by a location server to query for positioning measurements which are labelled or unlabelled, which is dependent on whether a supervised or unsupervised learning model is used. In one or more implementations, the location server trains and deploys the AI inference models with the aid of positioning measurement data received by the UEs or base stations. Additionally or alternatively, the AI inference models are trained at the UE and the base station, and then deployed at the location server. By utilizing the described techniques, various classification algorithms (e.g., Al inference models) can be readily trained to predict different metrics in time and space (e.g., PRS/SRS configuration, final location accuracy).

While AI techniques can be implemented to optimize and predict different metrics in time and space (e.g., PRS/SRS configuration, final location accuracy) within a positioning session of a target UE, well-trained AI inference models are needed to make such predictions accurately. The techniques discussed herein allow various measurements used to train an AI inference model to be specified by a location management function (LMF), collected, and reported to a training system that trains the AI inference model. For example, a set of measurements can be collected by a UE or a base station and labeled by associating each of one or more positioning measurements of the collected set of positioning measurements with any of various labels, such as an LOS path, an NLOS path, a number of detected paths, a polarization type, coherence bandwidth information, a channel frequency response, a Ricean factor, a combination thereof, and so forth. Having this collected data and associated labellings provides improved training data for training an AI inference model to predict different metrics in time and space within a positioning session of a UE.

Aspects of the present disclosure are described in the context of a wireless communications system. Aspects of the present disclosure are further illustrated and described with reference to device diagrams and flowcharts that relate to measurement and reporting for artificial intelligence based positioning.

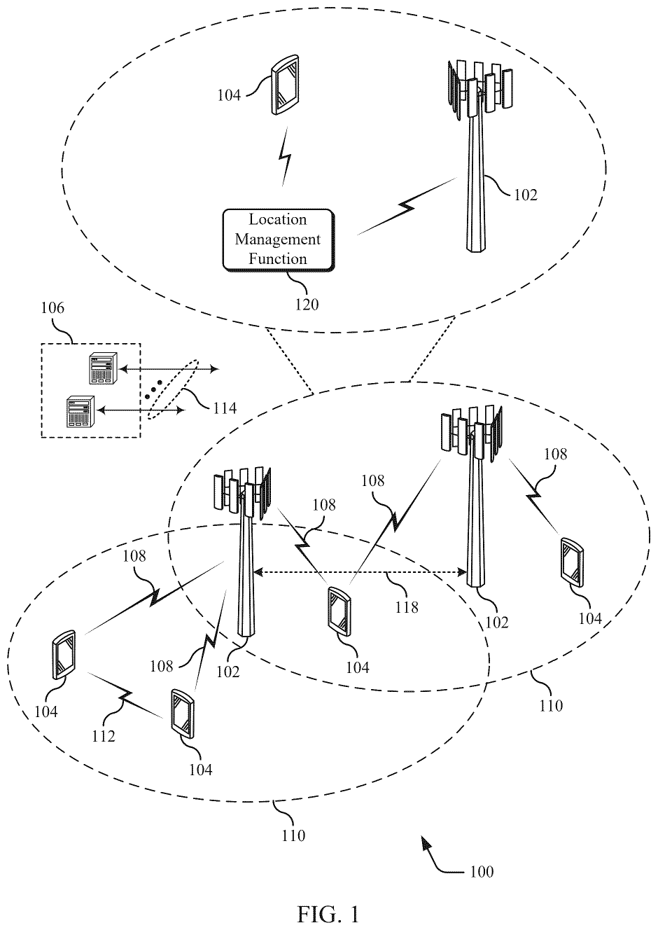

FIG. 1 illustrates an example of a wireless communications system 100 that supports measurement and reporting for artificial intelligence based positioning in accordance with aspects of the present disclosure. The wireless communications system 100 may include one or more base stations 102, one or more UEs 104, a core network 106. The wireless communications system 100 may support various radio access technologies. In some implementations, the wireless communications system 100 may be a 4G network, such as a long-term evolution (LTE) network or an LTE-Advanced (LTE-A) network. In some other implementations, the wireless communications system 100 may be a 5G network, such as a new radio (NR) network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be, or include, or may be referred to as a base transceiver station, an access point, a NodeB, an eNodeB (eNB), a next-generation NodeB (gNB), a Radio Head (RH), a relay node, an integrated access and backhaul (IAB) node, or other suitable terminology. A base station 102 and a UE 104 may communicate via a communication link 108, which may be a wireless or wired connection. For example, a base station 102 and a UE 104 may perform wireless communication over a NR-Uu interface.

A base station 102 may provide a geographic coverage area 110 for which the base station 102 may support services (e.g., voice, video, packet data, messaging, broadcast, etc.) for one or more UEs 104 within the geographic coverage area. For example, a base station 102 and a UE 104 may support wireless communication of signals related to services (e.g., voice, video, packet data, messaging, broadcast, etc.) according to one or multiple radio access technologies. In some implementations, a base station 102 may be moveable, such as when implemented as a gNB onboard a satellite or other non-terrestrial station (NTS) associated with a non-terrestrial network (NTN). In some implementations, different geographic coverage areas 110 associated with the same or different radio access technologies may overlap, and different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region or coverage area 110 of the wireless communications system 100. A UE 104 may include or may be referred to as a mobile device, a wireless device, a remote device, a handheld device, a customer premise equipment (CPE), a subscriber device, or as some other suitable terminology. In some implementations, the UE 104 may be referred to as a unit, a station, a terminal, or a client, among other examples. Additionally, or alternatively, a UE 104 may be referred to as an Internet-of-Things (IoT) device, an Internet-of-Everything (IoE) device, or as a machine-type communication (MTC) device, among other examples. In some implementations, a UE 104 may be stationary in the wireless communications system 100. In other implementations, a UE 104 may be mobile in the wireless communications system 100, such as an earth station in motion (ESIM).

The one or more UEs 104 may be devices in different forms or having different capabilities. Some examples of UEs 104 are illustrated in FIG. 1. A UE 104 may be capable of communicating with various types of devices, such as the base stations 102, other UEs 104, or network equipment (e.g., the core network 106, a relay device, a gateway device, an integrated access and backhaul (IAB) node, a location server that implements the location management function (LMF), or other network equipment). Additionally, or alternatively, a UE 104 may support communication with other base stations 102 or UEs 104, which may act as relays in the wireless communications system 100.

A UE 104 may also support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2, or other network interface). The base stations 102 may communicate with each other over the backhaul links 118 (e.g., via an X2, Xn, or another network interface). In some implementations, the base stations 102 may communicate with each other directly (e.g., between the base stations 102). In some other implementations, the base stations 102 may communicate with each other indirectly (e.g., via the core network 106). In some implementations, one or more base stations 102 may include subcomponents, such as an access network entity, which may be an example of an access node controller (ANC). The ANC may communicate with the one or more UEs 104 through one or more other access network transmission entities, which may be referred to as a radio heads, smart radio heads, gateways, transmission-reception points (TRPs), and other network nodes and/or entities.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)), and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

According to implementations, one or more of the UEs 104 and base stations 102 are operable to implement various aspects of measurement and reporting for artificial intelligence based positioning, as described herein. For instance, a LMF 120 may communicate with a UE 104 or a base station 102, sending a request message for the UE 104 or the base station 102 to output labelled positioning measurements to an AI training system. In response to the request message, the UE 104 or the base station 102 collects a set of positioning measurements, labels the collected set of positioning measurements, and outputs a response message including the labeled set of positioning measurements to the AI training system. The AI training system, which may be implemented at the UE 104, the base station 102, or the LMF 120, trains an AI inference model, which is used by the LMF 120 to output various predictions (e.g., radio environment prediction, prediction of location accuracy in different areas, and so forth).

With reference to new radio (NR) positioning based on NR Uu signals and SA architecture (e.g., beam-based transmissions), the target use cases also include commercial and regulatory (emergency services) scenarios. The 3GPP (release 17) defines the positioning performance requirements for commercial and IIoT use cases. For example, the positioning error requirement for end-to-end latency for a position estimate of a UE in a commercial use case is less than 100 ms, and in an IIoT use case is less than 100 ms, within the order of 10 ms being desired. However, these positioning performance requirements do not address obtaining a position estimate for a UE based on sidelink PRS.

The supported positioning techniques (release 16) are listed in Table TI, and separate positioning techniques can be currently configured and performed based on the requirements of the location management function (LMF) and UE capabilities. The transmission of PRS enable the UE to perform UE positioning-related measurements to enable the computation of a UE's location estimate and are configured per transmission reception point (TRP), where a TRP may transmit one or more beams. Various RAT-dependent positioning techniques (also referred to as positioning methods, or positioning procedures) are supported for a UE, for UE-assisted, LMF-based, and/or for NG-RAN node assisted. The RAT-dependent positioning techniques that are supported include downlink-time difference of arrival (DL-TDOA), downlink-angle of departure (DL-AoD), multi-round trip time (multi-RTT), new radio enhanced cell-ID (NR E-CID); uplink-time difference of arrival (UL-TDOA); and uplink-angle of arrival (UL-AoA).

TABLE T1
Supported Rel-16 UE positioning methods

| | | UE- | | |
|---|---|---|---|---|
| | | assisted, | NG-RAN | |
| | UE- | LMF- | node | |
| Method | based | based | assisted | SUPL |
| A-GNSS | Yes | Yes | No | Yes (UE-based and |
| | | | | UE-assisted) |
| OTDOA ^{Note1, Note 2} | No | Yes | No | Yes (UE-assisted) |
| E-CID ^{Note 4} | No | Yes | Yes | Yes for E-UTRA |
| | | | | (UE-assisted) |
| Sensor | Yes | Yes | No | No |
| WLAN | Yes | Yes | No | Yes |
| Bluetooth | No | Yes | No | No |
| TBS ^{Note 5} | Yes | Yes | No | Yes (MBS) |
| DL-TDOA | Yes | Yes | No | No |
| DL-AoD | Yes | Yes | No | No |
| Multi-RTT | No | Yes | Yes | No |
| NR E-CID | No | Yes | FFS | No |
| UL-TDOA | No | No | Yes | No |
| UL-AoA | No | No | Yes | No |

^{NOTE1}
This includes TBS positioning based on PRS signals.
^{NOTE 2}
In this version of the specification only OTDOA based on LTE signals is supported.
NOTE 3:
Void.
^{NOTE 4}
This includes Cell-ID for NR method.
^{NOTE 5}
In this version of the specification only for TBS positioning based on MBS signals.
NOTE 6:
Void

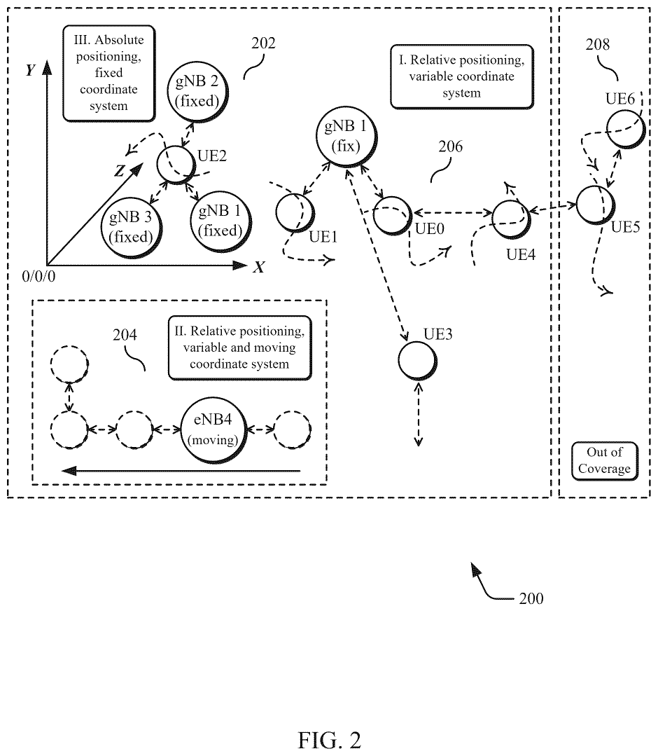

FIG. 2 illustrates an example 200 of absolute and relative positioning scenarios as related to measurement and reporting for artificial intelligence based positioning in accordance with aspects of the present disclosure. The network devices described with reference to example 200 may use and/or be implemented with the wireless communications system 100 and include UEs 104 and base stations 102 (e.g., eNB, gNB). The example 200 is an overview of absolute and relative positioning scenarios as defined in the architectural (stage 1) specifications using three different co-ordinate systems, including (III) a conventional absolute positioning, fixed coordinate system at 202; (II) a relative positioning, variable and moving coordinate system at 204; and (I) a relative positioning, variable coordinate system at 206. Notably, the relative positioning, variable coordinate system at 206 is based on relative device positions in a variable coordinate system, where the reference may be always changing with the multiple nodes that are moving in different directions. The example 200 also includes a scenario 208 for an out of coverage area in which UEs need to determine relative position with respect to each other.

With reference to RAT-dependent positioning techniques, the DL-TDOA positioning technique utilizes at least three network nodes for positioning based on triangulation. The DL-TDOA positioning method makes use of the downlink reference signal time difference (RSTD) (and optionally DL PRS RSRP) of downlink signals received from multiple transmission points (TPs) at the UE. The UE measures the downlink RSTD (and optionally DL PRS RSRP) of the received signals using assistance data received from the positioning server (also referred to herein as the location server), and the resulting measurements are used along with other configuration information to locate the UE in relation to the neighboring TPs.

The DL-AoD positioning technique makes use of the measured downlink PRS reference signal received power (RSRP) (DL PRS RSRP) of downlink signals received from multiple TPs at the UE. The UE measures the DL PRS RSRP of the received signals using assistance data received from the positioning server (also referred to herein as the location server), and the resulting measurements are used along with other configuration information to locate the UE in relation to the neighboring TPs.

FIG. 3 illustrates an example 300 of a multi-cell RTT procedure as related to measurement and reporting for artificial intelligence based positioning in accordance with aspects of the present disclosure. The multi-RTT positioning technique makes use of the UE Rx-Tx measurements and DL PRS RSRP of downlink signals received from multiple TRPs, as measured by the UE and the measured gNB Rx-Tx measurements and uplink sounding reference signal (SRS) RSRP (UL SRS-RSRP) at multiple TRPs of uplink signals transmitted from UE. The UE measures the UE Rx-Tx measurements (and optionally DL PRS RSRP of the received signals) using assistance data received from the positioning server (also referred to herein as the location server), and the TRPs the gNB Rx-Tx measurements (and optionally UL SRS-RSRP of the received signals) using assistance data received from the positioning server. The measurements are used to determine the RTT at the positioning server, which are used to estimate the location of the UE. The multi-RTT is only supported for UE-assisted and NG-RAN assisted positioning techniques as noted in Table TI.

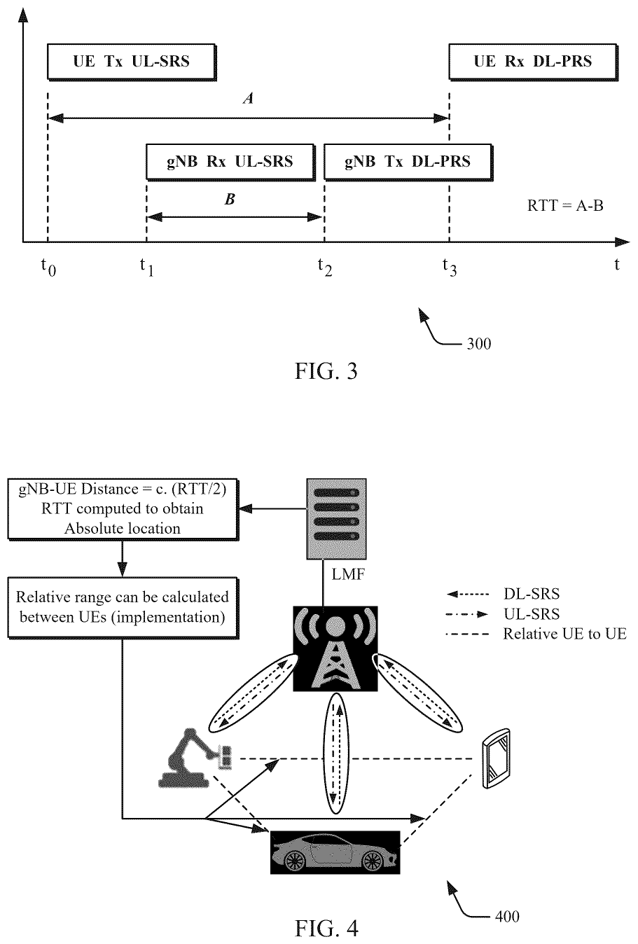

FIG. 4 illustrates an example of a system 400 for existing relative range estimation as related to measurement and reporting for artificial intelligence based positioning in accordance with aspects of the present disclosure. The system 400 illustrates the relative range estimation using the existing single gNB RTT positioning framework. The location server (LMF) can configure measurements to the different UEs, and then the target UEs can report their measurements in a transparent way to the location server. The location server can compute the absolute location, but in order to get the relative distance between two of the UEs, it would need prior information, such as the locations of the target UEs.

For the NR enhanced cell ID (E-CID) positioning technique, the position of a UE is estimated with the knowledge of its serving ng-eNB, gNB, and cell, and is based on LTE signals. The information about the serving ng-eNB, gNB, and cell may be obtained by paging, registration, or other methods. The NR enhanced cell-ID (NR E-CID) positioning refers to techniques which use additional UE measurements and/or NR radio resources and other measurements to improve the UE location estimate using NR signals. Although enhanced cell-ID (E-CID) positioning may utilize some of the same measurements as the measurement control system in the radio resource control (RRC) protocol, the UE may not make additional measurements for the sole purpose of positioning (i.e., the positioning procedures do not supply a measurement configuration or measurement control message, and the UE reports the measurements that it has available rather than being required to take additional measurement actions).

The uplink time difference of arrival (UL-TDOA) positioning technique makes use of the UL-TDOA (and optionally UL SRS-RSRP) at multiple reception points (RPs) of uplink signals transmitted from UE. The RPs measure the UL-TDOA (and optionally UL SRS-RSRP) of the received signals using assistance data received from the positioning server, and the resulting measurements are used along with other configuration information to estimate the location of the UE.

The uplink angle of arrival (UL-AoA) positioning technique makes use of the measured azimuth and the zenith of arrival at multiple RPs of uplink signals transmitted from UE. The RPs measure azimuth-AoA and zenith-AoA of the received signals using assistance data received from the positioning server (also referred to herein as the location server), and the resulting measurements are used along with other configuration information to estimate the location of the UE.

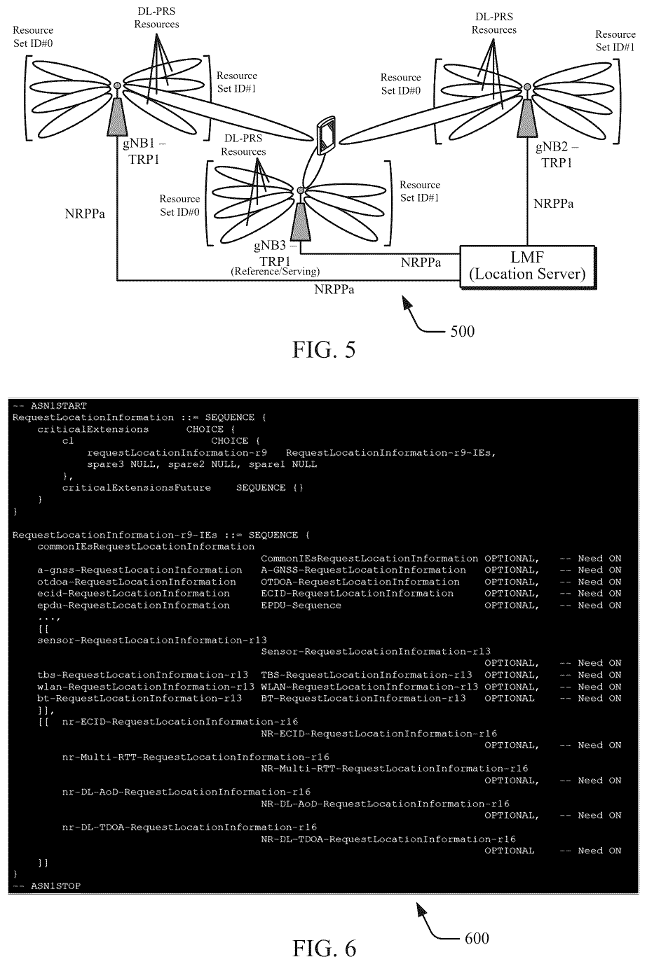

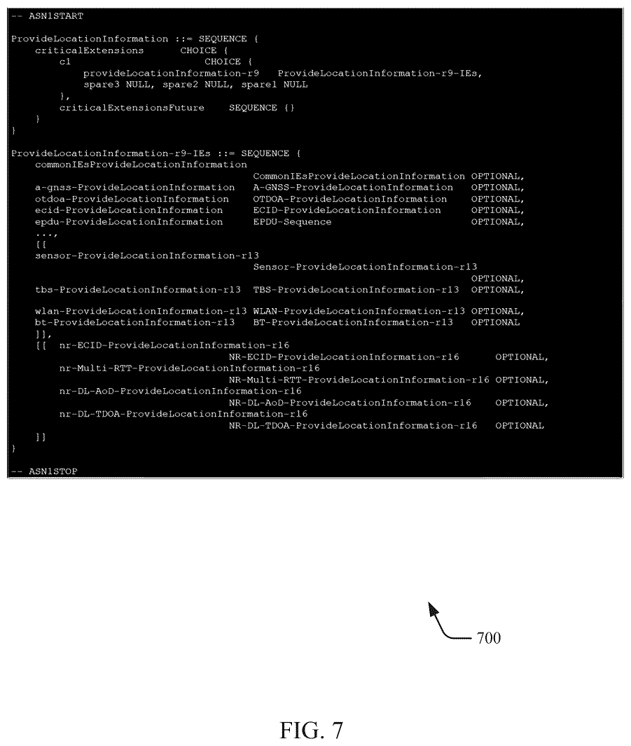

FIG. 5 illustrates an example of a system 500 of NR beam-based positioning as related to measurement and reporting for artificial intelligence based positioning in accordance with aspects of the present disclosure. The system 500 illustrates a UE 104 and base stations 102 (e.g., gNB). The PRS can be transmitted by different base stations (serving and neighboring) using narrow beams over FR1 and FR2 as illustrated in the example system 500, which is relatively different when compared to LTE where the PRS was transmitted across the whole cell. The PRS can be locally associated with a PRS Resource ID and Resource Set ID for a base station (TRP). Similarly, UE positioning measurements such as Reference Signal Time Difference (RSTD) and PRS RSRP measurements are made between beams (e.g., between a different pair of DL PRS resources or DL PRS resource sets) as opposed to different cells as was the case in LTE. In addition, there are additional UL positioning methods for the network to exploit in order to compute the target UE's location.

The Tables T2 and T3 show the reference signal to measurements mapping for each of the supported RAT-dependent positioning techniques at the UE and gNB, respectively. The RAT-dependent positioning techniques may utilize the 3GPP RAT and core network entities to perform the position estimation of the UE, which are differentiated from RAT-independent positioning techniques, which rely on GNSS, IMU sensor, WLAN, and Bluetooth technologies for performing target device (UE) positioning.

TABLE T2
UE measurements to enable RAT-
dependent positioning techniques.

| | | To facilitate |
|---|---|---|
| | | support of the |
| DL/UL Reference | | positioning |
| Signals | UE Measurements | techniques |
| Rel. 16 DL PRS | DL RSTD | DL-TDOA |
| Rel. 16 DL PRS | DL PRS RSRP | DL-TDOA, DL-AoD, |
| | | Multi-RTT |
| Rel. 16 DL | UE Rx − Tx time | Multi-RTT |
| PRS/Rel. 16 | difference | |
| SRS for positioning | | |
| Rel. 15 SSB/ | SS-RSRP(RSRP | NR E-CID |
| CSI-RS | for RRM), | |
| for RRM | SS-RSRQ(for RRM), | |
| | CSI-RSRP | |
| | (for RRM), CSI- | |
| | RSRQ (for RRM), SS- | |
| | RSRPB (for RRM) | |

TABLE T3
gNB measurements to enable RAT-dependent
positioning techniques.

| | | To facilitate |
|---|---|---|
| | | support of the |
| DL/UL Reference | | positioning |
| Signals | gNB Measurements | techniques |
| Rel. 16 SRS for | UL RTOA | UL-TDOA |
| positioning | | |
| Rel. 16 SRS for | UL SRS-REFERENCE | UL-TDOA, |
| positioning | SIGNAL RECEIVED | UL-AoA, |
| | POWER (RSRP) | Multi-RTT |
| Rel. 16 SRS for | gNB Rx −Tx time | Multi-RTT |
| positioning, Rel. 16 DL | difference | |
| PRS | | |
| Rel. 16 SRS for | AoA and ZoA | UL-AoA, |
| positioning | | Multi-RTT |

With reference to RAT-dependent positioning techniques, various RAT-independent positioning techniques can be used, such as network-assisted global navigation satellite system (GNSS) methods, barometric pressure sensor positioning, wireless local area network (WLAN) positioning, Bluetooth positioning, terrestrial beacon system (TBS) positioning, Motion sensor positioning, and so forth.

Network-assisted GNSS methods make use of UEs 104 that are equipped with radio receivers capable of receiving GNSS signals. In 3GPP specifications the term GNSS encompasses both global and regional/augmentation navigation satellite systems. Examples of global navigation satellite systems include GPS, Modernized GPS, Galileo, GLONASS, and BeiDou Navigation Satellite System (BDS). Regional navigation satellite systems include Quasi Zenith Satellite System (QZSS) while the many augmentation systems, are classified under the generic term of Space Based Augmentation Systems (SBAS) and provide regional augmentation services. Different GNSSs (e.g. GPS, Galileo, etc.) can be used separately or in combination to determine the location of a UE 104.

Barometric pressure sensor positioning makes use of barometric sensors to determine the vertical component of the position of the UE 104. The UE 104 measures barometric pressure, optionally aided by assistance data, to calculate the vertical component of its location or to send measurements to the positioning server for position calculation. This method can be combined with other positioning methods to determine the 3D position of the UE 104.

WLAN positioning makes use of the WLAN measurements (access point (AP) identifiers and optionally other measurements) and databases to determine the location of the UE 104. The UE 104 measures received signals from WLAN access points, optionally aided by assistance data, to send measurements to the positioning server for position calculation. Using the measurement results and a references database, the location of the UE 104 is calculated. Additionally or alternatively, the UE 104 makes use of WLAN measurements and optionally WLAN AP assistance data provided by the positioning server, to determine its location.

Bluetooth positioning makes use of Bluetooth measurements (beacon identifiers and optionally other measurements) to determine the location of the UE 104. The UE 104 measures received signals from Bluetooth beacons. Using the measurement results and a references database, the location of the UE 104 is calculated. The Bluetooth methods may be combined with other positioning methods (e.g., WLAN) to improve positioning accuracy of the UE 104.

TBS positioning consists of a network of ground-based transmitters, broadcasting signals only for positioning purposes. The current type of TBS positioning signals are the MBS (Metropolitan Beacon System) signals and Positioning Reference Signals (PRS). The UE 104 measures received TBS signals, optionally aided by assistance data, to calculate its location or to send measurements to the positioning server for position calculation.

Motion sensor positioning makes use of different sensors such as accelerometers, gyros, magnetometers, to calculate the displacement of UE 104. The UE 104 estimates a relative displacement based upon a reference position and/or reference time. The UE 104 sends a report comprising the determined relative displacement which can be used to determine the absolute position. This method can be used with other positioning methods for hybrid positioning.

With reference to a conceptual overview of the current Uu implementation (release 16), the overall measurement configuration and reporting is performed per configured RAT-dependent positioning method and/or RAT-independent positioning method.

FIG. 6 illustrates an example 600 of a LPP request location information (RequestLocationInformation) message as related to measurement and reporting for artificial intelligence based positioning, as described herein. The RequestLocationInformation message body in a LPP message is used by the location server to request positioning measurements or a position estimate from the target device.

FIG. 7 illustrates an example 700 of a LPP provide location information (ProvideLocationInformation) message as related to measurement and reporting for artificial intelligence based positioning, as described herein. The Provide LocationInformation message body in a LPP message is used by the target device to provide positioning measurements or position estimates to the location server.

With reference to RAT-dependent positioning measurements, the different downlink measurements, including DL PRS RSRP, downlink RSTD, and UE Rx-Tx time difference required for the supported RAT-dependent positioning techniques are shown in Table T4. The measurement configurations may include four (4) pair of downlink RSTD measurements performed per pair of cells, and each measurement is performed between a different pair of downlink PRS resources or resource sets with a single reference timing; and eight (8) downlink PRS reference signal received power (RSRP) measurements can be performed on different downlink PRS resources from the same cell.

TABLE T4
Downlink measurements for downlink-based positioning techniques.
DL PRS reference signal received power (DL PRS-RSRP)

| | |
|---|---|
| Definition | DL PRS-RSRP, is the linear average over the power contributions (in [W]) of |
| | the resource elements that carry DL PRS reference signals configured for |
| | RSRP measurements within the considered measurement frequency |
| | bandwidth. |
| | For frequency range 1, the reference point for the DL PRS-RSRP shall be the |
| | antenna connector of the UE. For frequency range 2, DL PRS-RSRP shall be |
| | measured based on the combined signal from antenna elements corresponding |
| | to a given receiver branch. For frequency range 1 and 2, if receiver diversity is |
| | in use by the UE, the reported DL PRS-RSRP value shall not be lower than |
| | the corresponding DL PRS-RSRP of any of the individual receiver branches. |
| Applicable for | RRC_CONNECTED intra-frequency, |
| | RRC_CONNECTED inter-frequency |

DL reference signal time difference (DL RSTD)

| | |
|---|---|
| Definition | DL reference signal time difference (DL RSTD) is the DL relative timing |
| | difference between the positioning node/and the reference positioning node i, |
| | defined as T_{SubframeRxj} − T_{SubframeRxi}, |
| | Where: |
| | T_{SubframeRxj} is the time when the UE receives the start of one subframe from |
| | positioning node j. |
| | T_{SubframeRxi} is the time when the UE receives the corresponding start of one |
| | subframe from positioning node i that is closest in time to the subframe |
| | received from positioning node j. |
| | Multiple DL PRS resources can be used to determine the start of one subframe |
| | from a positioning node. |
| | For frequency range 1, the reference point for the DL RSTD shall be the |
| | antenna connector of the UE. For frequency range 2, the reference point for |
| | the DL RSTD shall be the antenna of the UE. |
| Applicable for | RRC_CONNECTED intra-frequency |
| | RRC_CONNECTED inter-frequency |

UE Rx − Tx time difference

| | |
|---|---|
| Definition | The UE Rx − Tx time difference is defined as T_{UE-RX} − T_{UE-TX} |
| | Where: |
| | T_{UE-RX} is the UE received timing of downlink subframe #i from a positioning |
| | node, defined by the first detected path in time. |
| | T_{UE-TX} is the UE transmit timing of uplink subframe #j that is closest in time to |
| | the subframe #i received from the positioning node. |
| | Multiple DL PRS resources can be used to determine the start of one subframe |
| | of the first arrival path of the positioning node. |
| | For frequency range 1, the reference point for T_{UE-RX} measurement shall be the |
| | Rx antenna connector of the UE and the reference point for T_{UE-TX} |
| | measurement shall be the Tx antenna connector of the UE. For frequency |
| | range 2, the reference point for T_{UE-RX} measurement shall be the Rx antenna of |
| | the UE and the reference point for T_{UE-TX} measurement shall be the Tx antenna |
| | of the UE. |
| Applicable for | RRC_CONNECTED intra-frequency |
| | RRC_CONNECTED inter-frequency |

In aspects of this disclosure, various positioning agreements, as per 3GPP agreements, are taken into consideration. Reporting of LOS/NLOS indicators for DL, UL, and DL+UL positioning measurements taken at both UE and TRP at least for UE assisted positioning are considered. For example, the following options (or combinations of the following options) for LOS/NLOS indicators are considered: Binary (i.e., hard) value indicators, soft value indicators (i.e., [0,1]).

Multipath reporting enhancements for DL, UL, and DL+UL positioning to enable LOS/NLOS/multipath identification and mitigation at the LMF for UE-assisted positioning are considered.

For multipath reporting enhancements, reporting from TRP to LMF, angle, timing, phase (of additional paths) and power for the additional N paths (value of N is part of the study) are considered.

For multipath reporting enhancements, reporting from UE to LMF, relative timing of additional paths (additional to the first path) and the power (at least relative power) at least per DL PRS resource per additional path for at least DL-AoD reporting (the number of paths is part of the study) is considered.

Whether to support up to N>2 additional paths in the measurement reports from UE to LMF for at least DL-TDOA and multi-RTT is considered, including exact value of N, reporting the power of the paths in addition to the timing, and LMF requesting additional M non-distinct paths corresponding to the first path.

For LOS/NLOS information reporting, the following options for information to enable/assist LOS/NLOS detection are considered:
Polarization information reporting from UE/gNB to LMF.
Coherence bandwidth information reporting from UE/gNB to LMF.
Propagation time difference information reporting from UE/gNB to LMF.
RSRP reporting from UE/gNB to LMF with finer granularity
Ricean factor and the variance of Channel Frequency Response (CFR) information reporting from UE/gNB to LMF
No specification impact outside of LOS/NLOS reporting

For LOS/NLOS indicators, a single-indicator can be reported and the supported values are a discrete set in the interval [0, 1]. The number of discrete values to be supported is considered, and binary values only are not precluded. Single-indicator refers to one value in the interval [0, 1] is used for the LOS/NLOS indication.

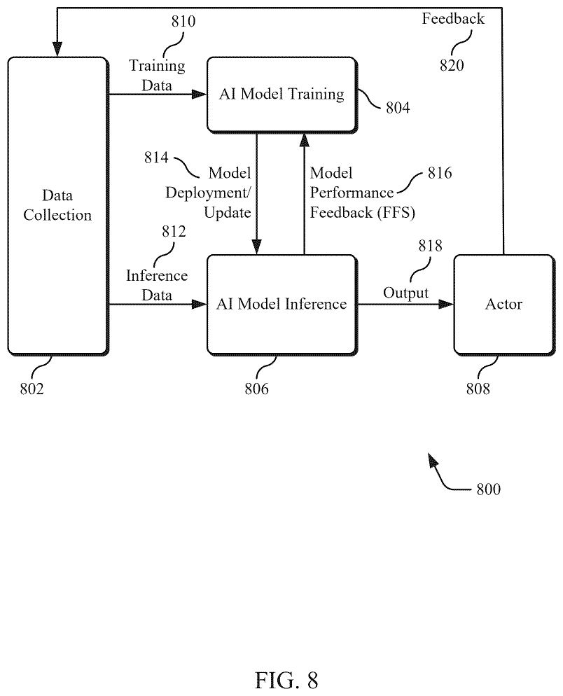

FIG. 8 illustrates an example training system 800 for training an AI inference model. The training system 800 includes data collection function 802, AI model training function 804, AI model inference function 806, and actor function 808.

Data collection function 802 is a function that provides input data (training data 810) to the AI model training function 804 and provides input data (inference data 812) to the AI model inference function 806. AI algorithm specific data preparation (e.g., data pre-processing and cleaning, formatting, and transformation) is not carried out in the data collection function 802. Examples of input data may include measurements from UEs or different network entities, feedback from actor function 808, output from an AI inference model, and so forth. The data collection function 802 provides training data 810.

AI model training function 804 is a function that performs the AI model training, validation, and testing which may generate model performance metrics as part of the model testing procedure. The AI model training function 804 is also responsible for data preparation (e.g., data pre-processing and cleaning, formatting, and transformation) based on the training data 810 delivered by the data collection function 802, if required. The AI model training function 804 provides model deployment/update 814, which is used to initially deploy a trained, validated, and tested AI inference model to the AI model Inference function 806 or to deliver an updated model to the AI model Inference function 806.

The AI model inference function 806 is a function that provides AI model inference output (e.g., predictions or decisions). The AI model inference function 806 provides model performance feedback 816 to the AI model training function 804. The AI model inference function 806 is also responsible for data preparation (e.g., data pre-processing and cleaning, formatting, and transformation) based on inference data 812 delivered by the data collection function 802, if required. The model performance feedback 816 is applied by the AI model training function 804 if certain information derived from the AI model inference function 806 is suitable for improvement of the AI inference model trained in the AI model training function 804. Feedback from the actor function 808 or other network entities (e.g., via the data collection function 802) may be needed at the AI model inference function 806 to create the model performance feedback 816.

The AI model inference function 806 outputs inference output 818 of the AI inference model produced by the AI model inference function 806. The actor function 808 is a function that receives the output 818 from the AI model inference function 806 and triggers or performs corresponding actions. The actor function 808 may trigger actions directed to other entities or to itself. The actor function 808 provides feedback 820 that may be needed to derive training or inference data or performance feedback.

Some positioning methodologies, considering industrial Internet of things (IIoT) scenarios, are vulnerable to NLOS and detrimental to location estimation degradation. The techniques discussed herein support an AI-based framework for each of multiple RAT-dependent positioning methods. These methods include a method to support efficient data collection via labelling of received positioning measurement data to exploit better positioning performance in supervised and unsupervised learning scenarios. The use of hidden features is considered to improve the training of the positioning measurement dataset. These methods also include a method to support signalling and message exchange for predicting the radio environment characteristics and positioning QoS via training and inference models deployed at the location server. These methods also include a method to support signalling and message exchange for predicting the radio environment characteristics and positioning QoS via training and inference models deployed at the UE and NG-RAN node, respectively.

In one or more implementations, an initiator device initiates an SL positioning/ranging session. A responder device responds to an SL positioning/ranging session from an initiator device.

It should be noted that that various techniques discussed herein may be implemented in combination with each other.

In the discussions herein, a positioning-related reference signal may be referred to as a reference signal used for positioning procedures/purposes in order to estimate a target UE's location, e.g., PRS, or based on existing reference signals such as CSI-RS or SRS. A target UE may be referred to as the device/entity to be localized/positioned. In various implementations, the term “PRS” may refer to any signal such as a reference signal, which may or may not be used primarily for positioning.

A target UE may be referred to as a UE of interest whose position (absolute or relative) is to be obtained by the network or by the UE itself.

Also in the discussions herein, the models that are described are based on AI, which may also be referred to as machine learning.

In one or more implementations, a method for enabling a mechanism to support the UE and base station signalling of RAT-dependent positioning measurement data, which may be labelled and/or unlabeled for input into the appropriate supervised/unsupervised AI model. This is especially applicable for UE-assisted positioning methods, where the AI models for discriminating LOS/NLOS measurement data are within the LMF.

The target UE may tag or label the positioning measurement data in different message containers depending on whether the requested measurements are required to be labelled or unlabeled with required feature associations.

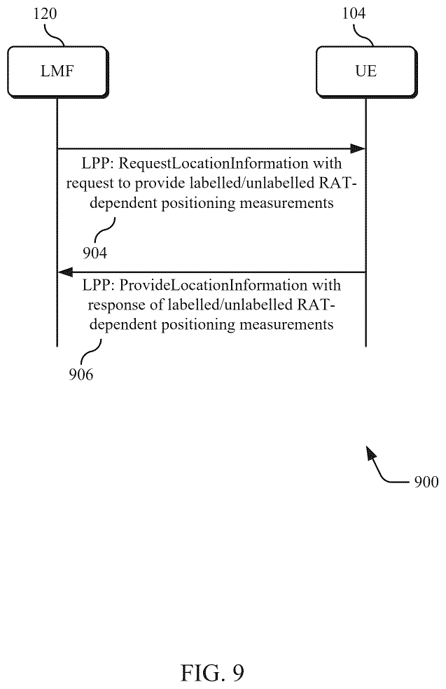

FIG. 9 illustrates an example procedure 900 of the message exchange between a UE and an LMF. In the illustrate example, the procedure 900 is between a UE 104 and an LMF 120. The procedure 900 allows the UE 104 to provide labelled/unlabelled positioning to the LMF 120 measurement data via existing LPP signalling. As illustrated, at 904 the LMF 120 transmits a request (RequestLocationInformation) with a request to provide labelled or unlabelled RAT-dependent positioning measurements. At 906, in response to the request at 904, the UE 104 transmits a response (ProvideLocationInformation) with a response of labelled or unlabelled RAT-dependent positioning measurements. Additionally or alternatively, the LMF 120 transmits the request (RequestLocationInformation) with a request to provide labelled or unlabelled RAT-dependent positioning measurements to base station 102, an in response to the request the base station 102 transmits a response (ProvideLocationInformation) with a response of labelled or unlabelled RAT-dependent positioning measurements for a UE 104.

In one or more implementations, the positioning measurement data is provided (e.g., labelled) per positioning technique, e.g., DL-TDOA, Multi-RTT, DL-AoD, and may vary according to the positioning technique and the applicable features required. Additionally or alternatively, the positioning measurement data is provided as a common set applicable to all positioning techniques, e.g., DL-PRS RSRP would be beneficial for all methods as additional measurement information.

Additionally or alternatively, the LMF 120 initiate the same request as shown in FIG. 9 with one or more base stations, for the request to receive labelled or unlabelled data for UL-based positioning measurements, e.g., SRS-RSRP, UL-AoA, etc.

Additionally or alternatively, one initiator UE 104 may request another responder UE 104 for labelled/unlabelled measurements in the context of SL positioning/ranging.

The positioning measurement data includes any of a variety of measurement positions. In one or more implementations, the position measurement data includes an LOS/NLOS measurement. If the classification of positioning measurements is not performed within the UE 104, the UE 104 may in addition also report the signal features such as amplitude, phase, delay, power delay profile, number of detected paths, and so forth. If the classification is performed within the UE 104, then the UE 104 may in addition also report the LOS/NLOS classification method, the probability of LOS/NLOS, a flag indication on whether the LOS/NLOS measurement is per path, and so forth. If the LOS/NLOS measurement has been made using AI-based approaches the model characteristics may also be shared with the LMF 120, e.g., training, validation, testing metrics of the data, whether a trained model or a model based on inference was used, number of layers or the like. Uncertainty of classification may also be reported.

Additionally or alternatively, the position measurement data includes a number of detected paths per measurement. The UE 104 may report the total number of received paths per measurement. Additionally or alternatively the UE 104 may report a subset of total paths as per its UE capability, in this case the selection criteria of the subset of total path may also be reported. Additionally or alternatively, the UE 104 may label the paths in order of signal reception, first path, second path, etc.

Additionally or alternatively, the position measurement data includes polarization information.

Additionally or alternatively, the position measurement data includes coherence bandwidth information.

Additionally or alternatively, the position measurement data includes Ricean factor and the variance of Channel Frequency Response (CFR) information.

The position measurement data may also be labelled according to different DL-PRS resource granularities ranging from positioning frequency layers, bandwidth parts, resource set, resources, TRP, or combinations thereof. This labelling also extends to the SRS configuration as well. The time series variation of the position measurement data may also be captured via additional labels such as timestamps, timing windows, and so forth.

The positioning measurements obtained from the UE 104 may be processed as unlabelled data, to which no prior knowledge and assistance information is applied to add structure or function of environment in which the measurements were performed, which in turn affects the accuracy and thus location estimation performance.

The provision of labelled and unlabelled data to the LMF 120 may be used as input to derive training models and/or inference models based on whether an AI is used to improve location performance, characterize the radio environment or predict the UE's location (e.g. enhanced tracking).

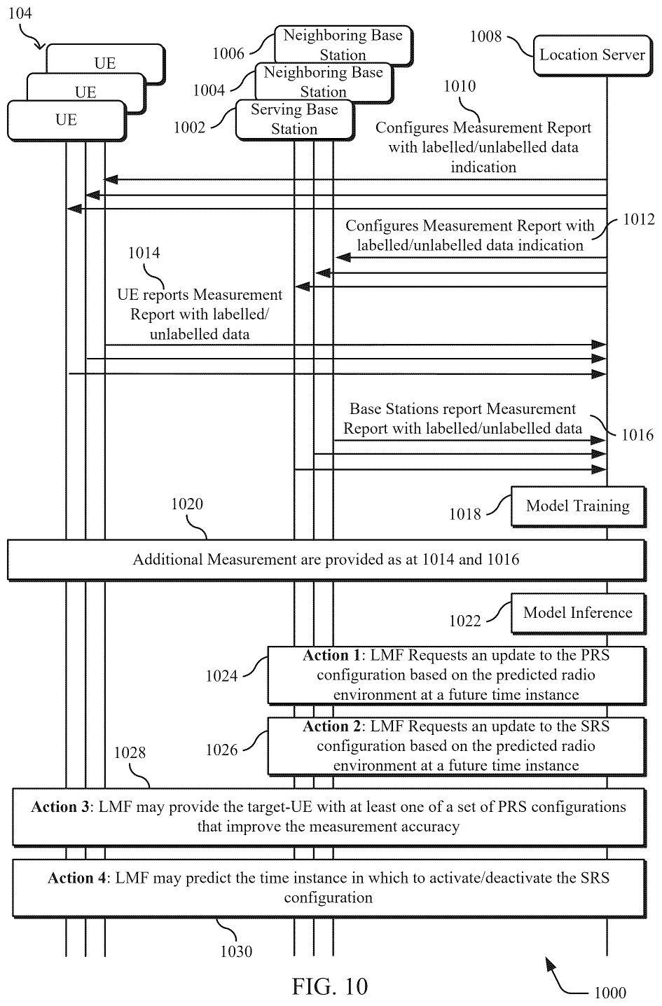

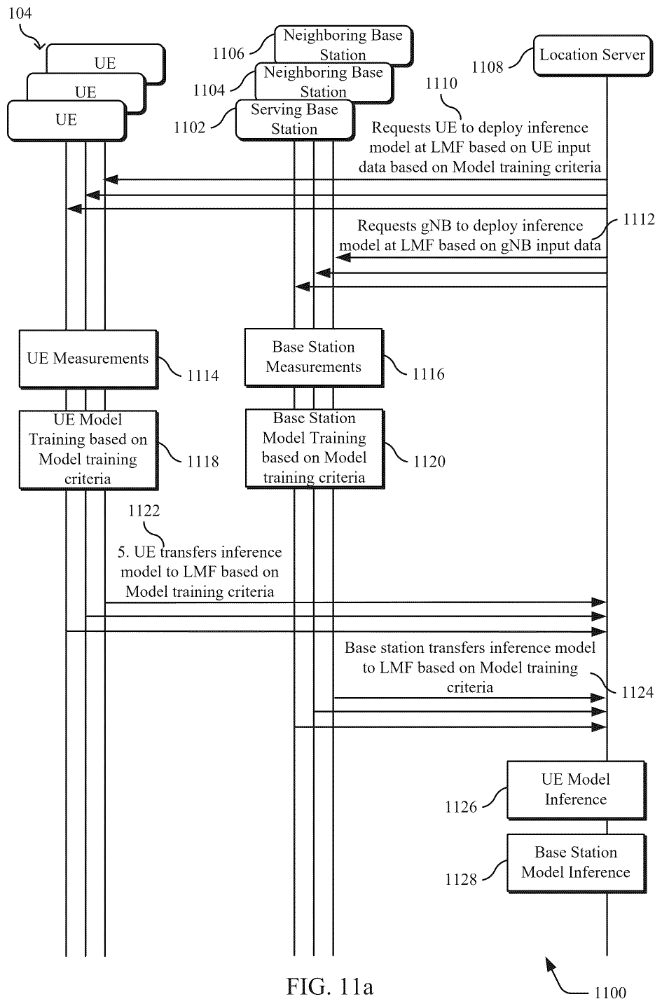

FIG. 10 illustrates an example procedure 1000 to support the data collection for both training and inference located in the LMF 120. Procedure 1000 shows multiple UEs 104, a serving base station 1002 (e.g., a serving NG-RAN), multiple neighboring base stations 1004 and 1006 (e.g., multiple neighboring NG-RAN nodes), and a location server 1008. The location server 1008 implements, for example, the LMF 120.

In the example procedure 1000, the measurement and reporting for artificial intelligence based positioning includes an AI inference model that is trained at, and used for inference, the LMF 120. The provisioning of labelled/unlabelled positioning measurements as provided by the target UE 104 (for DL-based positioning methods) and by the base station (for UL-based positioning methods), support an enhanced and efficient AI inference model framework for classification of positioning measurements to serve as the datasets for online/offline training of the AI inference model. The classification may aid the LMF 120 in categorizing the positioning measurements, which can lead to enhanced accuracy and prediction of the radio environment and QoS of the target UE 104.

At 1010, the location server 1008 (e.g., the LMF 120) configures the measurement configuration information for one or more target UEs 104 including whether to provide labelled or unlabelled measurement data. This configuration is performed, for example, by the location server 1008 transmitting, to the one or more target UEs, one or more requests (e.g., requests to output labelled or unlabelled measurement data) to the location server 1008.

At 1012, the location server 1008 (e.g., the LMF 120) configures the measurement configuration information for the serving base station 1002 and optionally one or more neighboring base stations 1004 and 1006, including whether to provide labelled or unlabelled measurement data. This configuration is performed, for example, by the location server 1008 transmitting, to the one or more base stations 1002, 1004, and 1006, one or more requests (e.g., requests to output labelled or unlabelled measurement data) to the location server 1008.

At 1014, the one or more target UEs 104 report the measurements to the location server 1008 in response to the request at 1010. For example, a UE 104 outputs, to the location server 1008, a response message including a labelled set of positioning measurements. This response message indicates, for example, deployment and training of an AI inference model using the labelled set of positioning measurements as discussed in more detail below.

At 1016, one or more of the base stations 1002, 1004, and 1006 reports the measurements to the location server 1008 in response to the request at 1012. For example, a base station 1002, 1004, or 1006 outputs, to the location server 1008, a response message including a labelled set of positioning measurements. This response message indicates, for example, deployment and training of an AI inference model using the labelled set of positioning measurements as discussed in more detail below.

At 1018, the location server 1008 receives one or more measurement reports (at 1014 and 1016) and uses both DL and UL positioning measurements to train an AI inference model. At least one supervised model may be trained (e.g., using labelled data) or one unsupervised model may be trained (using unlabelled data). However, there may be instances where the location server may train multiple models. Multiple models (supervised or unsupervised) may be trained based on utilization of base station or target UE 104 measurements or combination of both, based on a defined area in which the measurements were made (e.g., specific cell list, geographic area, etc.), based on a defined time duration in which the measurements were performed, and so forth.

At 1020, additional measurements are provided as at 1014 and 1016 to use as input into the trained AI inference model for the prediction.

At 1022, once the AI inference model has been trained, the UE 104 or base station measurements may continue to provide measurements to enable classification of positioning measurements which are then leveraged into the AI inference model to output the prediction, e.g., radio environment prediction (e.g., moving into an area with low/medium/high NLOS characteristics), predict location accuracy in different areas (e.g., in Area 1 the accuracy may be X meters, while in Area 2 the accuracy may be Y meters), and so forth.

At 1024, the location server 1008 may request the one or more base stations 1002, 1004, or 1006 update the PRS configuration by configuring, e.g., PRS resources with higher periodicity, denser PRS configuration pattern, based on the type of predicted radio environment, and so forth.

At 1026, the location server 1008 may request the one or more base stations 1002, 1004, or 1006 to update the SRS configuration by configuring, e.g., SRS resources with higher periodicity, denser SRS configuration pattern, based on the type of predicted radio environment, and so forth. This will also assist the LMF 120 in predicting the time instance in which to provide the SRS configuration.

At 1028, the location server 1008 may provide one or more target UEs 104 with at least one of a set of PRS configurations that improve the measurement accuracy based on the predicted radio environment characteristic.

At 1030, the location server 1008, may predict the time instance in which to activate/deactivate the SRS configuration via, e.g., NRPPa signalling to the NG-RAN node and MAC CE signalling from the base station to the UE.

In one or more implementations, at 1020 regarding the prediction of location information, various positioning QoS metrics may also be predicted to within a certain accuracy margin. In one or more implementations, absolute positioning accuracy (e.g., relative horizontal and vertical accuracies, lateral and longitudinal accuracies in the case of V2X) is predicted. Additionally or alternatively, relative positioning accuracy (e.g., relative horizontal and vertical accuracies, lateral and longitudinal accuracies in the case of V2X) is predicted. Additionally or alternatively, orientation accuracy (e.g., absolute or relative orientations) is predicted. Additionally or alternatively, mobility (e.g., absolute velocity including horizontal and vertical velocity estimates, relative velocity) is predicted. Additionally or alternatively, confidence intervals are predicted.

In one or more implementations, integrity and reliability of the positioning estimate is determined in various manners. In one or more implementations, an alert limit (AL) is predicted, which is the maximum allowable positioning error such that the positioning system is available for the intended application. If the positioning error is beyond the AL, operations are hazardous and the positioning system should be declared unavailable for the intended application to prevent loss of integrity. When the AL bounds the positioning error in the horizontal plane or on the vertical axis then it is also called a horizontal alert limit (HAL) or a vertical alert limit (VAL) respectively. Additionally or alternatively, a time to alert (TTA) is predicted, which is the probability that the positioning error exceeds the AL without warning the user within the required time to alert. Additionally or alternatively, a target integrity risk (TIR) is predicted, which is the maximum allowable elapsed time from when the positioning error exceeds the AL until the function providing position integrity annunciates a corresponding alert. The TIR is usually defined as a probability rate per some time unit (e.g., per hour, per second or per independent sample).

In one or more implementations, the input data set elements from one or more target UEs include:
RAT-dependent and/or RAT-independent positioning measurements (e.g., DL TDOA, UE Rx-Tx time difference, DL-AoD)
UE Radio measurements (e.g., RRM measurements) related to serving and neighboring cells associated with UE location information, e.g., coordinates, serving cell ID, moving velocity
UE mobility history (e.g., low, medium, high)
Velocity estimates

In one or more implementations, the input data set elements from one or more base stations include:
RAT-dependent and/or RAT-independent positioning measurements (e.g., UL RTOA, UL-AoA)
gNB Radio measurements (e.g., SRS-RSRP measurements) related to serving and neighboring cells associated with UE location information, e.g., coordinates, serving cell ID, moving velocity
UE mobility history (e.g., low, medium, high)
UE historical serving cells and their locations
Velocity estimates
TRP information (e.g., most frequented TRPs in terms of PRS transmissions)

In one or more implementations, the output data set elements from the location server 1008 include predicted positioning QoS metrics as described above, which may be used to update the PRS/SRS configuration depending on the characterized radio environment of the target UE.

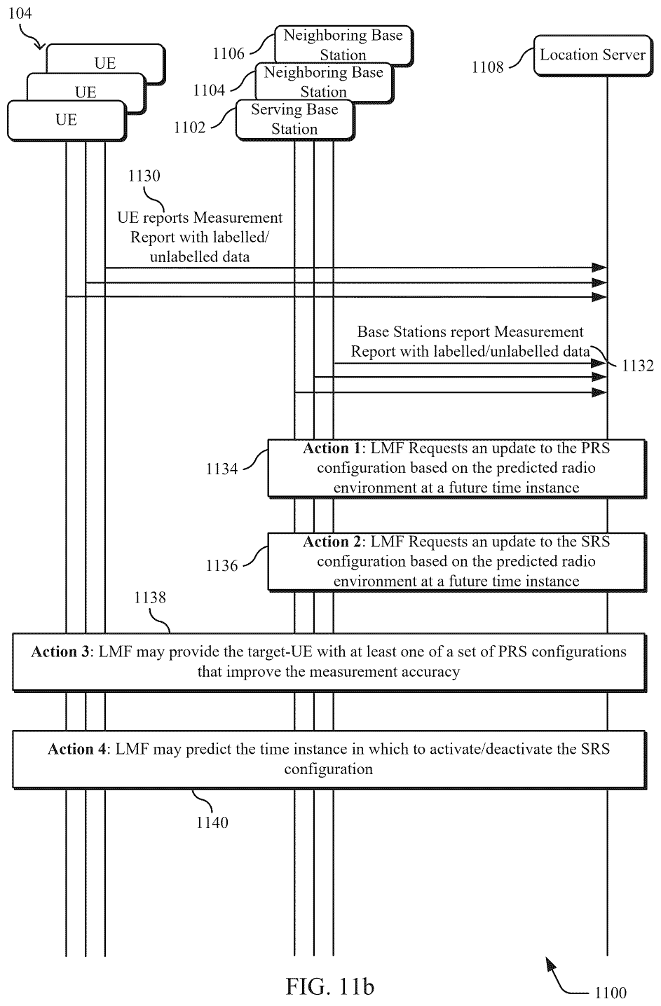

FIGS. 11a and 11b illustrate an example procedure 1100 to support the data collection for distributed training of AI inference models. Procedure 1100 shows multiple UEs 104, a serving base station 1102 (e.g., a serving NG-RAN), multiple neighboring base stations 1104 and 1106 (e.g., multiple neighboring NG-RAN nodes), and a location server 1108. The location server 1108 implements, for example, the LMF 120.

In the example procedure 1100, the signalling overhead and functionality achieved by the location server 1108 of procedure 1000 of FIG. 10 is distributed to the base stations and the UEs for prediction analytics of the positioning QoS. The UEs and base stations may each establish their respective AI-based training of AI inference models and then have the capability to deploy their respective trained AI inference models at the location server 1108.

At 1110 of FIG. 11a, the location server 1108 (e.g., the LMF 120) transmits a request to one or more UEs 104 to each transfer and deploy a UE trained AI inference model at the location server 1108 including information related to the model training criteria and indication whether to provide labelled or unlabelled data.

At 1112, the location server 1108 (e.g., the LMF 120) transmits a request to one or more base stations 1102, 1104, and 1106 to transfer and deploy a base station trained AI inference model at the location server 1108 including information related to the model training criteria and indication whether to provide labelled or unlabelled data.

At 1114, each target UE 104 inputs its own performed positioning measurements into its own UE training system, which can be labelled or unlabelled depending on if the AI inference model is supervised or unsupervised. Each target UE 104 collects a set of positioning measurements. In one or more implementations, if the AI inference model is supervised, the UE 104 labels the collected set of positioning measurements by associating each of one or more positioning measurements of the collected set of positioning measurements with any of various labels, such as an LOS path, an NLOS path, a number of detected paths, a polarization type, coherence bandwidth information, a channel frequency response, a Ricean factor, a combination thereof, and so forth.

At 1116, one or more of base stations 1102, 1104, and 1106 each inputs its own performed positioning measurements into its own UE training model, which can be labelled or unlabelled depending on if the AI model is supervised or unsupervised. Each such base station 1102, 1104, or 1106 collects a set of positioning measurements. In one or more implementations, if the AI inference model is supervised, the base station 1102, 1104, or 1106 labels the collected set of positioning measurements by associating each of one or more positioning measurements of the collected set of positioning measurements with any of various labels, such as an LOS path, an NLOS path, a number of detected paths, a polarization type, coherence bandwidth information, a channel frequency response, a Ricean factor, a combination thereof, and so forth.

It should be noted that the same labels may be used by both UE 104 and base stations 1102, 1104, and 1106, but need not be overlapping in time. For example, on one occasion the UE 104 may provide labelled measurements based on LOS/NLOS, while the base station 1102, 1104, or 1106 may provide labelled measurements based on only number of detected paths.

At 1118, each target UE 104 trains its own AI inference model based on the UE-based measurements. At least one supervised or unsupervised model may be trained but there may be instances where the UE may train multiple models, based on the model training criteria including, a defined area in which the measurements were made (e.g., specific TRP/cell list, geographic area comprising either latitude/longitude coordinates, etc.), a defined time duration in which the measurements were performed, and so forth. In one or more implementations, if the AI inference model is supervised, the UE 104 labels the collected set of positioning measurements by associating each of one or more positioning measurements of the collected set of positioning measurements with any of various labels, such as an LOS path, an NLOS path, a number of detected paths, a polarization type, coherence bandwidth information, a channel frequency response, a Ricean factor, a combination thereof, and so forth.

At 1120, one or more of base stations 1102, 1104, and 1106 each trains its own model based on the base station based measurements. At least one supervised or unsupervised model may be trained but there may be instances where the UE may train multiple models, based on the model training criteria including, a defined area in which the measurements were made (e.g., specific TRPs/cell list, geographic area comprising either latitude/longitude coordinates, etc.), a defined time duration in which the measurements were performed, based on threshold number of served target-UEs, and so forth. In one or more implementations, if the AI inference model is supervised, the base station 1102, 1104, or 1106 labels the collected set of positioning measurements by associating each of one or more positioning measurements of the collected set of positioning measurements with any of various labels, such as an LOS path, an NLOS path, a number of detected paths, a polarization type, coherence bandwidth information, a channel frequency response, a Ricean factor, a combination thereof, and so forth.

At 1122 the one or more target UEs 104 each transfers the UE trained, based on the requested model training criteria, AI inference model to the location server 1108.

At 1124, one or more of the base stations 1102, 1104, and 1106 each transfers the base station trained, based on the requested model training criteria, AI inference model to the location server 1108.

At 1126, the UE trained AI inference model may be leveraged to enable classification of UE positioning measurements which are then leveraged into the AI inference model to output the prediction, e.g., radio environment prediction (e.g., moving into an area with low/medium/high NLOS characteristics), predict location accuracy in different areas (e.g., In Area 1, the accuracy may be X meters, while in Area 2 the accuracy may be Y meters), and so forth.

At 1128, the base model trained inference model may be leveraged to enable classification of positioning measurements which are then are leveraged into the AI inference model to output the prediction, e.g., radio environment prediction (e.g., moving into an area with low/medium/high NLOS characteristics), predict location accuracy in different areas (e.g., In TRP Set 1, the accuracy may be X meters, while in TRP Set 2 the accuracy may be Y meters), and so forth.

At 1130 of FIG. 11b, additional UE measurements may be reported by the one or more target UEs 104 to the location server 1108 as input into the AI inference model (e.g., the UE trained AI inference model) for the desired prediction.

At 1132, additional base station measurements may be reported by one or more of the base stations 1102, 1104, and 1106 to the location server 1108 as input into the AI inference model (e.g., the base station trained AI inference model) for the desired prediction.

At 1134, the location server 1108 may request the one or more base stations 1102, 1104, or 1106 update the PRS configuration by configuring, e.g., PRS resources with higher periodicity, denser PRS configuration pattern, based on the type of predicted radio environment, and so forth.

At 1136, the location server 1108 may request the one or more base stations 1102, 1104, or 1106 update the SRS configuration by configuring, e.g., SRS resources with higher periodicity, denser SRS configuration pattern, based on the type of predicted radio environment, and so forth. This will also assist the LMF 120 in predicting the time instance in which to provide the SRS configuration.

At 1138, the location server 1108 may provide one or more of the target UEs 104 with at least one of a set of PRS configurations that improve the measurement accuracy based on the predicted radio environment characteristic.

At 1140, the location server 1108 may predict the time instance in which to activate/deactivate the SRS configuration.

Each of the AI inference models derived at a UE 1104 and/or a base station 1102, 1104, or 1106 may be associated with an ID, which may be transferred in the contained message at 1130 and/or 1132, respectively.

In one or more implementations, at 1126 and 1128 regarding the prediction of location information, various positioning QoS metrics may also be predicted to within a certain accuracy margin. In one or more implementations, absolute positioning accuracy (e.g., relative horizontal and vertical accuracies, lateral and longitudinal accuracies in the case of V2X) is predicted. Additionally or alternatively, relative positioning accuracy (e.g., relative horizontal and vertical accuracies, lateral and longitudinal accuracies in the case of V2X) is predicted. Additionally or alternatively, orientation accuracy (e.g., absolute or relative orientations) is predicted. Additionally or alternatively, mobility (e.g., absolute velocity including horizontal and vertical velocity estimates, relative velocity) is predicted. Additionally or alternatively, confidence intervals are predicted.

In one or more implementations, integrity and reliability of the positioning estimate is determined in various manners. In one or more implementations, an alert limit (AL) is predicted, which is the maximum allowable positioning error such that the positioning system is available for the intended application. If the positioning error is beyond the AL, operations are hazardous and the positioning system should be declared unavailable for the intended application to prevent loss of integrity. When the AL bounds the positioning error in the horizontal plane or on the vertical axis then it is also called a horizontal alert limit (HAL) or a vertical alert limit (VAL) respectively. Additionally or alternatively, a time to alert (TTA) is predicted, which is the probability that the positioning error exceeds the AL without warning the user within the required time to alert. Additionally or alternatively, a target integrity risk (TIR) is predicted, which is the maximum allowable elapsed time from when the positioning error exceeds the AL until the function providing position integrity annunciates a corresponding alert. The TIR is usually defined as a probability rate per some time unit (e.g., per hour, per second or per independent sample).

In one or more implementations, the input data set elements from one or more target UEs include:
RAT-dependent and/or RAT-independent positioning measurements (e.g., DL TDOA, UE Rx-Tx time difference, DL-AoD)
UE Radio measurements (e.g., RRM measurements) related to serving and neighboring cells associated with UE location information, e.g., coordinates, serving cell ID, moving velocity
UE mobility history (e.g., low, medium, high)
Velocity estimates

In one or more implementations, the input data set elements from one or more base stations include:
RAT-dependent and/or RAT-independent positioning measurements (e.g., UL RTOA, UL-AoA)
gNB Radio measurements (e.g., SRS-RSRP measurements) related to serving and neighboring cells associated with UE location information, e.g., coordinates, serving cell ID, moving velocity
UE mobility history (e.g., low, medium, high)
UE historical serving cells and their locations
Velocity estimates
TRP information (e.g., most frequented TRPs in terms of PRS transmissions)

In one or more implementations, the output data set elements from the location server 1108 include predicted positioning QoS metrics as described above, which may be used to update the PRS/SRS configuration depending on the characterized radio environment of the target UE.

In the embodiments discussed herein, the signalling exchange may be achieved using various signalling, such as LPP/RRC signalling. Furthermore, broadcast signalling may be used to transfer the labelled/unlabelled data indication as well as request to deploy a UE inference model at the LMF 120, e.g., using a new positioning system information blocks (posSIB) types. The posSIB are system information messages broadcasted by the base station to be used by multiple UEs. A new system information block can be defined to carry the request of labelling/unlabelling positioning measurement data and request to deploy the inference model via this type of broadcast signalling.

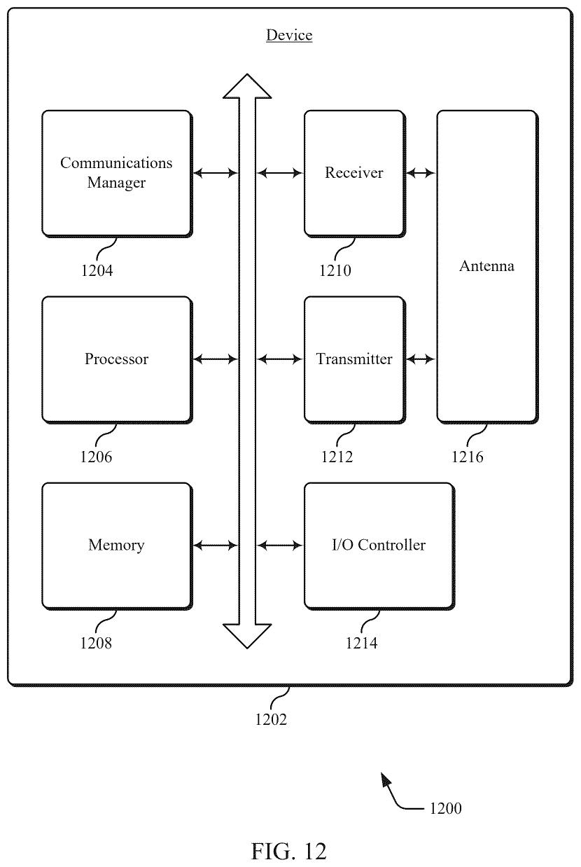

FIG. 12 illustrates an example of a block diagram 1200 of a device 1202 that supports measurement and reporting for artificial intelligence based positioning in accordance with aspects of the present disclosure. The device 1202 may be an example of a UE 104 as described herein or a base station 102. The device 1202 may support wireless communication and/or network signaling with one or more other base stations 102, other UEs 104, or any combination thereof. The device 1202 may include components for bi-directional communications including components for transmitting and receiving communications, such as a communications manager 1204, a processor 1206, a memory 1208, a receiver 1210, a transmitter 1212, and an I/O controller 1214. These components may be in electronic communication or otherwise coupled (e.g., operatively, communicatively, functionally, electronically, electrically) via one or more interfaces (e.g., buses).

The communications manager 1204, the receiver 1210, the transmitter 1212, or various combinations thereof or various components thereof may be examples of means for performing various aspects of the present disclosure as described herein. For example, the communications manager 1204, the receiver 1210, the transmitter 1212, or various combinations or components thereof may support a method for performing one or more of the functions described herein.

In some implementations, the communications manager 1204, the receiver 1210, the transmitter 1212, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1206 and the memory 1208 coupled with the processor 1206 may be configured to perform one or more of the functions described herein (e.g., by executing, by the processor 1206, instructions stored in the memory 1208).

Additionally or alternatively, in some implementations, the communications manager 1204, the receiver 1210, the transmitter 1212, or various combinations or components thereof may be implemented in code (e.g., as communications management software or firmware) executed by the processor 1206. If implemented in code executed by the processor 1206, the functions of the communications manager 1204, the receiver 1210, the transmitter 1212, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 1204 may be configured to perform various operations (e.g., receiving, monitoring, transmitting) using or otherwise in cooperation with the receiver 1210, the transmitter 1212, or both. For example, the communications manager 1204 may receive information from the receiver 1210, send information to the transmitter 1212, or be integrated in combination with the receiver 1210, the transmitter 1212, or both to receive information, transmit information, or perform various other operations as described herein. Although the communications manager 1204 is illustrated as a separate component, in some implementations, one or more functions described with reference to the communications manager 1204 may be supported by or performed by the processor 1206, the memory 1208, or any combination thereof. For example, the memory 1208 may store code, which may include instructions executable by the processor 1206 to cause the device 1202 to perform various aspects of the present disclosure as described herein, or the processor 1206 and the memory 1208 may be otherwise configured to perform or support such operations.

For example, the communications manager 1204 may support wireless communication and/or network signaling at a device (e.g., the device 1202, a UE or a base station) in accordance with examples as disclosed herein. The communications manager 1204 and/or other device components may be configured as or otherwise support an apparatus, such as a UE or base station, including a transceiver; and a processor coupled to the transceiver, the processor and the transceiver configured to cause the apparatus to: receive, from a location server, a request message to output labelled positioning measurements to an AI training system; collect a set of positioning measurements based at least in part on the received request message; label the collected set of positioning measurements by associating each of one or more positioning measurements of the collected set of positioning measurements with a LOS path, a NLOS path, UE location information, a number of detected paths, or a combination thereof; and output a response message including the labelled set of positioning measurements to the AI training system based at least in part on the received request message from the location server, the response message indicating deployment and training of an AI inference model using the labelled set of positioning measurements.

Additionally, the apparatus (e.g., a UE or base station) includes any one or combination of: where, to label the collected set of positioning measurements, the processor and the transceiver are configured to cause the apparatus to: label the collected set of positioning measurements by associating each of one or more positioning measurements of the collected set of positioning measurements with a polarization type, coherence bandwidth information, a channel frequency response, or a Ricean factor, or a combination thereof; where, to output the labelled set of positioning measurements, the processor and the transceiver are configured to cause the apparatus to: transmit, to the location server, the response message including the labelled set of positioning measurements, the location server including the AI training system, where the response message including an indication signaling to the location server to deploy the AI inference model at the location server, where, to output the labelled set of positioning measurements, the processor and the transceiver are configured to cause the apparatus to: output the labelled set of positioning measurements to the AI training system at the apparatus; enable the AI training system to train the AI inference model; and transmit the trained AI inference model to the location server; where the set of positioning measurements includes positioning measurements obtained using DL-based positioning techniques including one or more of DL-TDOA, DL-AoD, DL-E-CID, UL-based positioning techniques including one or more of UL-RTOA, UL-AoA, UL-E-CID, or both UL and DL-based positioning techniques including Multi-RTT; where, to label the collected set of positioning measurements, the processor and the transceiver are configured to cause the apparatus to: add labels to the positioning measurements according to DL-PRS and SRS resource granularities including positioning frequency layers, bandwidth parts, resource set, resources, TRPs, or combinations thereof; where the processor and the transceiver are further configured to cause the apparatus to receive, from the location server, a request via NRPPa signalling for an updated DL-PRS configuration based on the AI inference model deployed at the location server; where the processor and the transceiver are further configured to cause the apparatus to receive, from the location server, a request via NRPPa signalling for an updated SRS configuration based on the AI inference model deployed at the location server; where the processor and the transceiver are further configured to cause the apparatus to receive, from the location server via LPP signalling, an updated DL-PRS configuration based on the AI inference model deployed at the location server; where the processor and the transceiver are further configured to cause the apparatus to: receive, from the location server, activation messaging via NRPPa; and activate, in response to the activation messaging, an updated SRS configuration received via MAC CE based on the AI inference model deployed at the location server; where the AI training system uses model training criteria including a defined area and time duration for which the AI inference model is valid; where the processor and the transceiver are further configured to cause the apparatus to transfer the AI inference model, trained by the AI training system at the apparatus, to the location server via LPP and NRPPa signalling; where the apparatus comprises a UE or a base station; where the apparatus is one of a UE, a reference UE, an anchor UE, a base station, a next-generation NodeB centralized unit (gNB-CU), a next-generation NodeB distributed unit (gNB-DU), a remote radio head, and a smart repeater.

The communications manager 1204 and/or other device components may be configured as or otherwise support a means for wireless communication and/or network signaling at a UE or a base station, including receiving, from a location server, a request message to output labelled positioning measurements to an artificial intelligence (AI) training system; collecting a set of positioning measurements based at least in part on the received request message; labelling the collected set of positioning measurements by associating each of one or more positioning measurements of the collected set of positioning measurements with a line-of-sight (LOS) path, a non-line-of-sight (NLOS) path, UE location information, a number of detected paths, or a combination thereof; and outputting a response message including the labelled set of positioning measurements to the AI training system based at least in part on the received request message from the location server, the response message indicating deployment and training of an AI inference model using the labelled set of positioning measurements.

Additionally, wireless communication at the UE includes any one or combination of: where the device comprises a UE; where the device comprises a base station; labelling the collected set of positioning measurements including associating each positioning measurement with at least one of polarization type, coherence bandwidth information, channel frequency response, or Ricean factor; the outputting the response message includes transmitting the labelled set of positioning measurements to the location server, where the response message comprises an indication to deploy the AI inference model at the location server; the outputting the response message includes outputting the response message to the AI training system at the device, the method further including: training the AI inference model; and transmitting the trained AI inference model to the location server; the indication to provide a set of labelled positioning measurements includes positioning measurements obtained using DL-based positioning techniques including one or more of DL-TDOA, DL-AOD, DL-E-CID, UL-based positioning techniques including one or more of UL-RTOA, UL-AoA, UL-E-CID, or both UL and DL-based positioning techniques including Multi-RTT; the labelling the collected set of positioning measurements including adding labels to the positioning measurements according to DL-PRS and SRS resource granularities including positioning frequency layers, bandwidth parts, resource set, resources, TRPs or combinations thereof; receiving, from the location server, a request via NRPPa signalling for an updated DL-PRS configuration based on the AI inference model deployed at the location server; further including receiving, from the location server, a request via NRPPa signalling for an updated SRS configuration based on the AI inference model deployed at the location server; further including receiving, from the location server via LPP signalling, an updated DL-PRS configuration based on the AI inference model deployed at the location server; further including receiving, from the location server, activation messaging via NRPPa, and activating, in response to the activation messaging, an updated SRS configuration received via MAC CE based on the AI inference model deployed at the location server; where the AI training system uses model training criteria including a defined area and time duration for which the AI inference model is valid; further including training the AI inference model and transferring the trained AI inference model to the location server via LPP and NRPPa signalling.

The processor 1206 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1206 may be configured to operate a memory array using a memory controller. In some other implementations, a memory controller may be integrated into the processor 1206. The processor 1206 may be configured to execute computer-readable instructions stored in a memory (e.g., the memory 1208) to cause the device 1202 to perform various functions of the present disclosure.

The memory 1208 may include random access memory (RAM) and read-only memory (ROM). The memory 1208 may store computer-readable, computer-executable code including instructions that, when executed by the processor 1206 cause the device 1202 to perform various functions described herein. The code may be stored in a non-transitory computer-readable medium such as system memory or another type of memory. In some implementations, the code may not be directly executable by the processor 1206 but may cause a computer (e.g., when compiled and executed) to perform functions described herein. In some implementations, the memory 1208 may include, among other things, a basic I/O system (BIOS) which may control basic hardware or software operation such as the interaction with peripheral components or devices.

The I/O controller 1214 may manage input and output signals for the device 1202. The I/O controller 1214 may also manage peripherals not integrated into the device 1202. In some implementations, the I/O controller 1214 may represent a physical connection or port to an external peripheral. In some implementations, the I/O controller 1214 may utilize an operating system such as IOS®, ANDROID®, MS-DOS®, MS-WINDOWS®, OS/2®, UNIX®, LINUX®, or another known operating system. In some implementations, the I/O controller 1214 may be implemented as part of a processor, such as the processor 1206. In some implementations, a user may interact with the device 1202 via the I/O controller 1214 or via hardware components controlled by the I/O controller 1214.

In some implementations, the device 1202 may include a single antenna 1216. However, in some other implementations, the device 1202 may have more than one antenna 1216, which may be capable of concurrently transmitting or receiving multiple wireless transmissions. The receiver 1210 and the transmitter 1212 may communicate bi-directionally, via the one or more antennas 1216, wired, or wireless links as described herein. For example, the receiver 1210 and the transmitter 1212 may represent a wireless transceiver and may communicate bi-directionally with another wireless transceiver. The transceiver may also include a modem to modulate the packets, to provide the modulated packets to one or more antennas 1216 for transmission, and to demodulate packets received from the one or more antennas 1216.

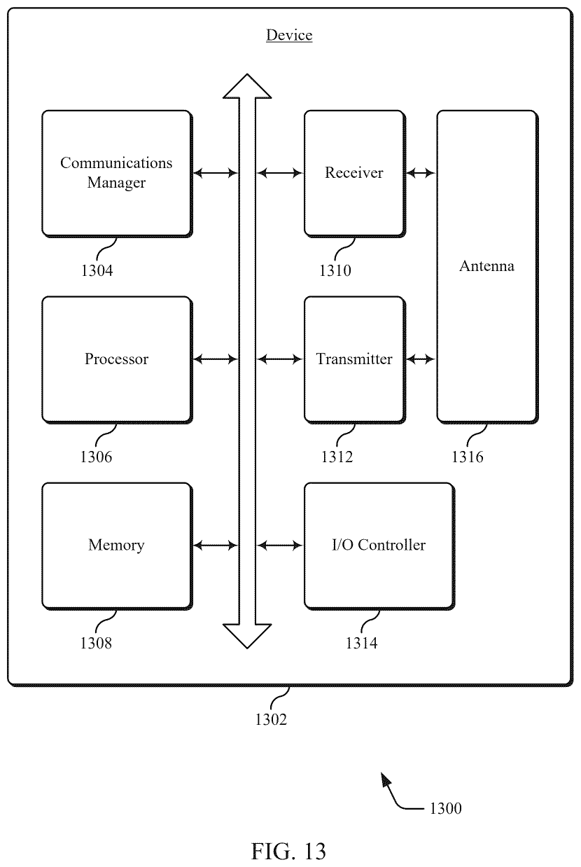

FIG. 13 illustrates an example of a block diagram 1300 of a device 1302 that supports measurement and reporting for artificial intelligence based positioning in accordance with aspects of the present disclosure. The device 1302 may be an example a device in a core network 106, such as a location server 1008 or a location server 1108 implementing a LMF 120 as described herein. The device 1302 may support wireless communication and/or network signaling with one or more base stations 102, UEs 104, or any combination thereof. The device 1302 may include components for bi-directional communications including components for transmitting and receiving communications, such as a communications manager 1304, a processor 1306, a memory 1308, a receiver 1310, a transmitter 1312, and an I/O controller 1314. These components may be in electronic communication or otherwise coupled (e.g., operatively, communicatively, functionally, electronically, electrically) via one or more interfaces (e.g., buses).

The communications manager 1304, the receiver 1310, the transmitter 1312, or various combinations thereof or various components thereof may be examples of means for performing various aspects of the present disclosure as described herein. For example, the communications manager 1304, the receiver 1310, the transmitter 1312, or various combinations or components thereof may support a method for performing one or more of the functions described herein.

In some implementations, the communications manager 1304, the receiver 1310, the transmitter 1312, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1306 and the memory 1308 coupled with the processor 1306 may be configured to perform one or more of the functions described herein (e.g., by executing, by the processor 1306, instructions stored in the memory 1308).

Additionally or alternatively, in some implementations, the communications manager 1304, the receiver 1310, the transmitter 1312, or various combinations or components thereof may be implemented in code (e.g., as communications management software or firmware) executed by the processor 1306. If implemented in code executed by the processor 1306, the functions of the communications manager 1304, the receiver 1310, the transmitter 1312, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 1304 may be configured to perform various operations (e.g., receiving, monitoring, transmitting) using or otherwise in cooperation with the receiver 1310, the transmitter 1312, or both. For example, the communications manager 1304 may receive information from the receiver 1310, send information to the transmitter 1312, or be integrated in combination with the receiver 1310, the transmitter 1312, or both to receive information, transmit information, or perform various other operations as described herein. Although the communications manager 1304 is illustrated as a separate component, in some implementations, one or more functions described with reference to the communications manager 1304 may be supported by or performed by the processor 1306, the memory 1308, or any combination thereof. For example, the memory 1308 may store code, which may include instructions executable by the processor 1306 to cause the device 1302 to perform various aspects of the present disclosure as described herein, or the processor 1306 and the memory 1308 may be otherwise configured to perform or support such operations.

For example, the communications manager 1304 may support wireless communication and/or network signaling at a device (e.g., the device 1302, location server) in accordance with examples as disclosed herein. The communications manager 1304 and/or other device components may be configured as or otherwise support an apparatus, such as a location server, including a transceiver to transmit and receive; and a processor coupled to the transceiver, the processor and the transceiver configured to cause the apparatus to: transmit, to a target device, a request message to output an indication to provide a set of labelled positioning measurements to an artificial intelligence (AIAI) training system, where the labelling of positioning measurements includes collecting a set of positioning measurements and labelling the collected set of positioning measurements by associating each of one or more positioning measurements of the collected set of positioning measurements with at least one of an line-of-sight (LOS) path, an non-line-of-sight (NLOLS) path, UE location information, or a number of detected paths, or a combination thereof; receive, from the AI training system, an AI inference model that was trained using the labelled set of positioning measurements data, the labelled positioning measurement data including collected positioning measurements and labels added to the collected positioning measurements; deploy, at the apparatus, the AI inference model that was trained using the labelled set of positioning measurements data; and apply the AI inference model to predict radio environment characteristics and corresponding positioning QoS of the target device.

Additionally, the apparatus (e.g., a location server) includes any one or combination of: where, to predict the radio environment characteristics and corresponding positioning QoS, the processor and the transceiver are configured to cause the apparatus to predict the radio environment characteristics and corresponding positioning QoS for one or more of a future time interval, a time window, or a single time instance; where, to predict the radio environment characteristics and corresponding positioning QoS, the processor and the transceiver are configured to cause the apparatus to predict the radio environment characteristics and corresponding positioning QoS for one or more of a future area, region, or a geographical zone in which the UE is expected be located at; where the radio environment characteristics include one or more of LOS or NLOS radio propagation links, multipath links, interference sources, RSRP, SNR, and SINR; where to predict the radio environment characteristics and corresponding positioning QoS, the processor and the transceiver are configured to cause the apparatus to predict the radio environment characteristics and corresponding positioning QoS for one or more of a future area, region, or a geographical zone; where the positioning QoS includes one or more of absolute and relative positioning accuracy, orientation accuracy, velocity estimates, confidence intervals, integrity, or reliability; where the processor and the transceiver are further configured to cause the apparatus to request to transfer and deploy the AI inference model trained at the target device based on model training criteria; where the target device comprises a UE; where the target device comprises a base station; where the labelling of positioning measurements includes associating each positioning measurement with at least one of polarization type, coherence bandwidth information, channel frequency response, or Ricean factor; where to receive the AI inference model is to receive the AI inference model from an AI training system implemented at the apparatus; where to receive the AI inference model is to receive the AI inference model from an AI training system implemented at the target device.

The communications manager 1304 and/or other device components may be configured as or otherwise support a means for wireless communication and/or network signaling at a location server, including transmitting, to a target device, a request message to output labelled positioning measurements to an AI training system, where the labelling of positioning measurements includes collecting a set of positioning measurements and labelling the collected set of positioning measurements by associating each of one or more positioning measurements of the collected set of positioning measurements with at least one of a LOS path, a NLOS path, UE location information, a number of detected paths, or a combination thereof; receiving, from the AI training system, an AI inference model that was trained using the labelled set of positioning measurements; deploying, at the device, the AI inference model that was trained using the labelled set of positioning measurements; and applying the AI inference model to predict radio environment characteristics and corresponding positioning QoS of the target device.

Additionally, wireless communication at the UE includes any one or combination of: the applying the AI inference model to predict radio environment characteristics and corresponding positioning QoS including predicting the radio environment characteristics and corresponding positioning QoS for one or more of a future time interval, a time window, or a single time instance; the applying the AI inference model to predict radio environment characteristics and corresponding positioning QoS including predicting the radio environment characteristics and corresponding positioning QoS for one or more of a future area, region, or a geographical zone in which the UE is expected be located at; the applying the AI inference model to predict radio environment characteristics and corresponding positioning QoS including predicting the radio environment characteristics and corresponding positioning QoS for one or more of a future area, region, or a geographical zone; where the radio environment characteristics include one or more of LOS or NLOS radio propagation links, multipath links, interference sources, reference RSRP, SNR, and SINR; where the positioning QoS includes one or more of absolute and relative positioning accuracy, orientation accuracy, velocity estimates, confidence intervals, integrity, or reliability; further including requesting to transfer and deploy the AI inference model trained at the target device based on model training criteria; where the target device comprises a UE; where the target device comprises a base station; where the labelling of positioning measurements includes associating each positioning measurement with at least one of polarization type, coherence bandwidth information, channel frequency response, or Ricean factor; the receiving the AI inference model including receiving the AI inference model from an AI training system implemented at the device; the receiving the AI inference model including receiving the AI inference model from an AI training system implemented at the target device.

The processor 1306 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1306 may be configured to operate a memory array using a memory controller. In some other implementations, a memory controller may be integrated into the processor 1306. The processor 1306 may be configured to execute computer-readable instructions stored in a memory (e.g., the memory 1308) to cause the device 1302 to perform various functions of the present disclosure.

The memory 1308 may include random access memory (RAM) and read-only memory (ROM). The memory 1308 may store computer-readable, computer-executable code including instructions that, when executed by the processor 1306 cause the device 1302 to perform various functions described herein. The code may be stored in a non-transitory computer-readable medium such as system memory or another type of memory. In some implementations, the code may not be directly executable by the processor 1306 but may cause a computer (e.g., when compiled and executed) to perform functions described herein. In some implementations, the memory 1308 may include, among other things, a basic I/O system (BIOS) which may control basic hardware or software operation such as the interaction with peripheral components or devices.

The I/O controller 1314 may manage input and output signals for the device 1302. The I/O controller 1314 may also manage peripherals not integrated into the device 1302. In some implementations, the I/O controller 1314 may represent a physical connection or port to an external peripheral. In some implementations, the I/O controller 1314 may utilize an operating system such as iOS®, ANDROID®, MS-DOS®, MS-WINDOWS®, OS/2®, UNIX®, LINUX®, or another known operating system. In some implementations, the I/O controller 1314 may be implemented as part of a processor, such as the processor 1306. In some implementations, a user may interact with the device 1302 via the I/O controller 1314 or via hardware components controlled by the I/O controller 1314.

In some implementations, the device 1302 may include a single antenna 1316. However, in some other implementations, the device 1302 may have more than one antenna 1316, which may be capable of concurrently transmitting or receiving multiple wireless transmissions. The receiver 1310 and the transmitter 1312 may communicate bi-directionally, via the one or more antennas 1316, wired, or wireless links as described herein. For example, the receiver 1310 and the transmitter 1312 may represent a wireless transceiver and may communicate bi-directionally with another wireless transceiver. The transceiver may also include a modem to modulate the packets, to provide the modulated packets to one or more antennas 1316 for transmission, and to demodulate packets received from the one or more antennas 1316.

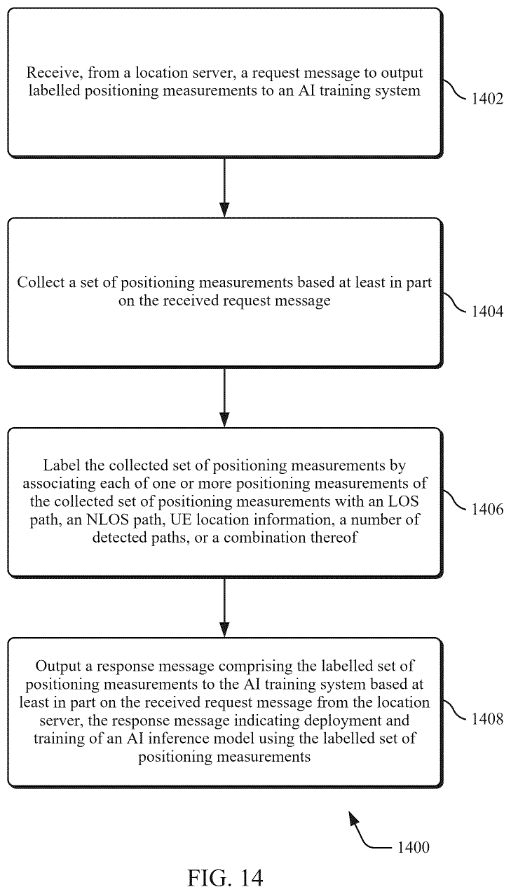

FIG. 14 illustrates a flowchart of a method 1400 that supports measurement and reporting for artificial intelligence based positioning in accordance with aspects of the present disclosure. The operations of the method 1400 may be implemented by a device or its components as described herein. For example, the operations of the method 1400 may be performed by a device, such as UE 104 or a base station 102 as described with reference to FIGS. 1 through 13. In some implementations, the device may execute a set of instructions to control the function elements of the device to perform the described functions. Additionally, or alternatively, the device may perform aspects of the described functions using special-purpose hardware.

At 1402, the method may include receiving, from a location server, a request message to output labelled positioning measurements to an AI training system. The operations of 1402 may be performed in accordance with examples as described herein. In some implementations, aspects of the operations of 1402 may be performed by a device as described with reference to FIG. 1.

At 1404, the method may include collecting a set of positioning measurements based at least in part on the received request message. The operations of 1404 may be performed in accordance with examples as described herein. In some implementations, aspects of the operations of 1404 may be performed by a device as described with reference to FIG. 1.

At 1406, the method may include labelling the collected set of positioning measurements by associating each of one or more positioning measurements of the collected set of positioning measurements with an LOS path, an NLOS path, UE location information, a number of detected paths, or a combination thereof. The operations of 1406 may be performed in accordance with examples as described herein. In some implementations, aspects of the operations of 1406 may be performed by a device as described with reference to FIG. 1.

At 1408, the method may include outputting a response message comprising the labelled set of positioning measurements to the AI training system based at least in part on the received request message from the location server, the response message indicating deployment and training of an AI inference model using the labelled set of positioning measurements. The operations of 1408 may be performed in accordance with examples as described herein. In some implementations, aspects of the operations of 1408 may be performed by a device as described with reference to FIG. 1.

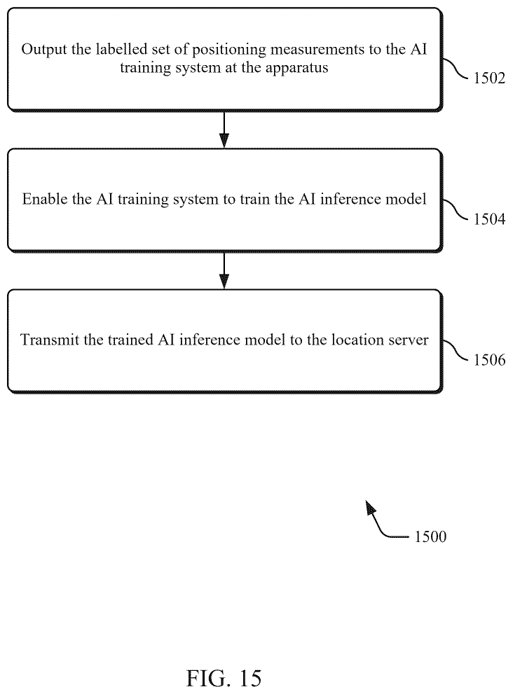

FIG. 15 illustrates a flowchart of a method 1500 that supports measurement and reporting for artificial intelligence based positioning in accordance with aspects of the present disclosure. The operations of the method 1500 may be implemented by a device or its components as described herein. For example, the operations of the method 1500 may be performed by a device, such as UE 104 or a base station 102 as described with reference to FIGS. 1 through 13. In some implementations, the device may execute a set of instructions to control the function elements of the device to perform the described functions. Additionally, or alternatively, the device may perform aspects of the described functions using special-purpose hardware.

At 1502, the method may include outputting the labelled set of positioning measurements to the AI training system at the apparatus. The operations of 1502 may be performed in accordance with examples as described herein. In some implementations, aspects of the operations of 1502 may be performed by a device as described with reference to FIG. 1.

At 1504, the method may include enabling the AI training system to train the AI inference model. The operations of 1504 may be performed in accordance with examples as described herein. In some implementations, aspects of the operations of 1504 may be performed by a device as described with reference to FIG. 1.

At 1506, the method may include transmitting the trained AI inference model to the location server. The operations of 1506 may be performed in accordance with examples as described herein. In some implementations, aspects of the operations of 1506 may be performed by a device as described with reference to FIG. 1.

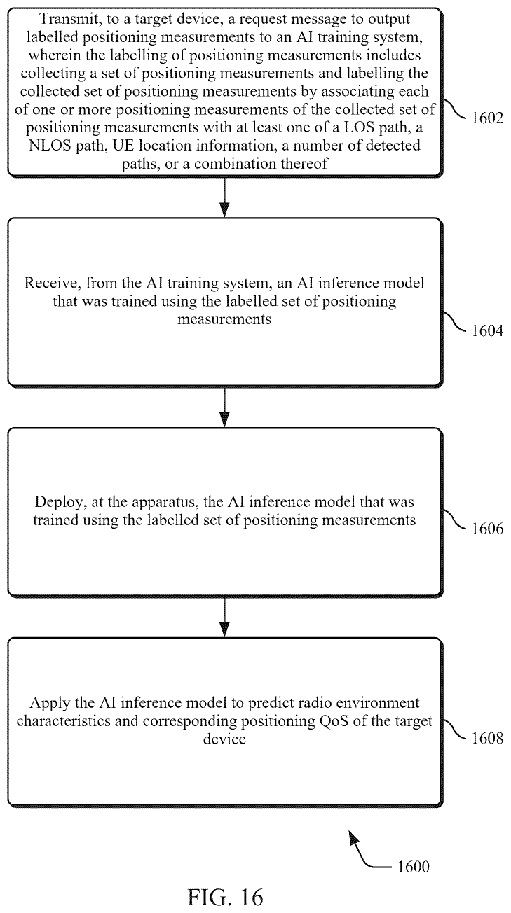

FIG. 16 illustrates a flowchart of a method 1600 that supports measurement and reporting for artificial intelligence based positioning in accordance with aspects of the present disclosure. The operations of the method 1600 may be implemented by a device or its components as described herein. For example, the operations of the method 1600 may be performed by a device implementing an LMF, such as device in the core network 106 as described with reference to FIGS. 1 through 13. In some implementations, the device may execute a set of instructions to control the function elements of the device to perform the described functions. Additionally, or alternatively, the device may perform aspects of the described functions using special-purpose hardware.

At 1602, the method may include transmitting, to a target device, a request message to output labelled positioning measurements to an AI training system, wherein the labelling of positioning measurements includes collecting a set of positioning measurements and labelling the collected set of positioning measurements by associating each of one or more positioning measurements of the collected set of positioning measurements with at least one of a LOS path, a NLOS path, UE location information, a number of detected paths, or a combination thereof. The operations of 1602 may be performed in accordance with examples as described herein. In some implementations, aspects of the operations of 1602 may be performed by a device as described with reference to FIG. 1.

At 1604, the method may include receiving, from the AI training system, an AI inference model that was trained using the labelled set of positioning measurements. The operations of 1604 may be performed in accordance with examples as described herein. In some implementations, aspects of the operations of 1604 may be performed by a device as described with reference to FIG. 1.

At 1606, the method may include deploying, at the apparatus, the AI inference model that was trained using the labelled set of positioning measurements. The operations of 1606 may be performed in accordance with examples as described herein. In some implementations, aspects of the operations of 1606 may be performed by a device as described with reference to FIG. 1.

At 1608, the method may include applying the AI inference model to predict radio environment characteristics and corresponding positioning QoS of the target device. The operations of 1608 may be performed in accordance with examples as described herein. In some implementations, aspects of the operations of 1608 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined. The order in which the methods are described is not intended to be construed as a limitation, and any number or combination of the described method operations may be performed in any order to perform a method, or an alternate method.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication, comprising:
at least one memory; and
at least one processor coupled with the at least one memory and configured to cause the apparatus to:
receive, from a location server, a request message to output labelled positioning measurements to an artificial intelligence (AI) training system;
collect a set of positioning measurements based at least in part on the received request message;
label the collected set of positioning measurements by associating each of one or more positioning measurements of the collected set of positioning measurements with a line-of-sight (LOS) path, a non-line-of-sight (NLOS) path, user equipment (UE) location information, a number of detected paths, or a combination thereof; and
output a response message comprising the labelled set of positioning measurements to the AI training system based at least in part on the received request message from the location server, the response message indicating deployment and training of an AI model using the labelled set of positioning measurements.

2. The apparatus of claim 1, wherein, to label the collected set of positioning measurements, the at least one processor is configured to cause the apparatus to:
label the collected set of positioning measurements by associating each of one or more positioning measurements of the collected set of positioning measurements based on a received label indication.

3. The apparatus of claim 1, wherein, to output the labelled set of positioning measurements, the at least one processor is configured to cause the apparatus to:
transmit, to the location server, the response message comprising the labelled set of positioning measurements, the location server comprising the AI training system, wherein the response message comprising an indication signaling to the location server to deploy the AI model at the location server.

4. The apparatus of claim 1, wherein, to output the labelled set of positioning measurements, the at least one processor is configured to cause the apparatus to:
output the labelled set of positioning measurements to the AI training system at the apparatus;
enable training of the AI model based on the labelled set of positioning measurements; and
transmit the trained AI model to the location server.

5. The apparatus of claim 1, wherein the set of positioning measurements includes positioning measurements obtained using DL-based positioning techniques including one or more of downlink time difference of arrival (DL-TDOA), downlink angle-of-departure (DL-AoD), downlink enhanced cell-ID (DL-E-CID), UL-based positioning techniques including one or more of uplink relative time of arrival (UL-RTOA), uplink angle-of-arrival (UL-AoA), uplink enhanced cell-ID (UL-E-CID), or both UL and DL-based positioning techniques including multicell round trip time (Multi-RTT), and the at least one processor is configured to cause the apparatus to:
add labels to the positioning measurements according to downlink positioning reference signals (DL-PRS) and sounding reference signal (SRS) resource granularities comprising positioning frequency layers, bandwidth parts, resource set, resources, transmission-reception points (TRPs) or timestamps or combinations thereof.

6. (canceled)

7. The apparatus of claim 1, wherein the at least one processor is further configured to cause the apparatus to receive, from the location server, a request via new radio positioning protocol annex (NRPPa) signalling for an updated downlink positioning reference signals (DL-PRS) configuration based on the AI model deployed at the location server.

8. The apparatus of claim 1, wherein the at least one processor is further configured to cause the apparatus to receive, from the location server, a request via new radio positioning protocol annex (NRPPa) signalling for an updated sounding reference signal (SRS) configuration based on the AI model deployed at the location server.

9. The apparatus of claim 1, wherein the at least one processor is further configured to cause the apparatus to receive, from the location server via long-term evolution positioning protocol (LPP) signalling, an updated downlink positioning reference signals (DL-PRS) configuration based on the AI model deployed at the location server.

10. The apparatus of claim 1, wherein the at least one processor is further configured to cause the apparatus to:
receive, from the location server, activation messaging via new radio positioning protocol annex (NRPPa); and
activate, in response to the activation messaging, an updated sounding reference signal (SRS) configuration received via medium access control (MAC) control element (CE) based on the AI inference model deployed at the location server.

11. The apparatus of claim 1, wherein the AI training system uses model training criteria including a defined area and time duration for which the AI model is valid.

12. The apparatus of claim 1, wherein the at least one processor is further configured to cause the apparatus to transfer the AI model, trained by the AI training system at the apparatus, to the location server via long-term evolution positioning protocol (LPP) and new radio positioning protocol annex (NRPPa) signalling.

13. The apparatus of claim 1, wherein the apparatus comprises a user equipment (UE) or a base station.

14. An apparatus, comprising:
at least one memory; and
at least one processor coupled with the at least one memory and configured to cause the apparatus to:
transmit, to a target device, a request message to output labelled positioning measurements to an artificial intelligence (AI) training system, wherein the labelling of positioning measurements includes collecting a set of positioning measurements and labelling the collected set of positioning measurements by associating each of one or more positioning measurements of the collected set of positioning measurements with at least one of a line-of-sight (LOS) path, a non-line-of-sight (NLOS) path, user equipment (UE) location information, a number of detected paths, or a combination thereof;
receive, from the AI training system, an AI model that was trained using the labelled set of positioning measurements;
deploy, at the apparatus, the AI model that was trained using the labelled set of positioning measurements; and
apply the AI model to predict radio environment characteristics and corresponding positioning quality of service (QOS) of the target device.

15. The apparatus of claim 14, wherein, to predict the radio environment characteristics and corresponding positioning QoS, the at least one processor is configured to cause the apparatus to predict the radio environment characteristics and corresponding positioning QoS for one or more of a future time interval, a time window, or a single time instance, wherein the radio environment characteristics include one or more of LOS or NLOS radio propagation links, multipath links, interference sources, reference signal received power (RSRP), signal to noise ratio (SNR), and signal to interference noise ratio (SINR).

16. (canceled)

17. The apparatus of claim 14, wherein to predict the radio environment characteristics and corresponding positioning QoS, the at least one processor is configured to cause the apparatus to predict the radio environment characteristics and corresponding positioning QoS for one or more of a future area, region, or a geographical zone.

18. (canceled)

19. (canceled)

20. A method for wireless communication at a device, the method comprising:
receiving, from a location server, a request message to output labelled positioning measurements to an artificial intelligence (AI) training system;
collecting a set of positioning measurements based at least in part on the received request message;
labelling the collected set of positioning measurements by associating each of one or more positioning measurements of the collected set of positioning measurements with a line-of-sight (LOS) path, a non-line-of-sight (NLOS) path, user equipment (UE) location information, a number of detected paths, or a combination thereof; and
outputting a response message comprising the labelled set of positioning measurements to the AI training system based at least in part on the received request message from the location server, the response message indicating deployment and training of an AI model using the labelled set of positioning measurements.

21. A processor for wireless communication, comprising:
at least one controller coupled with at least one memory and configured to cause the processor to:
receive, from a location server, a request message to output labelled positioning measurements to an artificial intelligence (AI) training system;
collect a set of positioning measurements based at least in part on the received request message;
label the collected set of positioning measurements by associating each of one or more positioning measurements of the collected set of positioning measurements with a line-of-sight (LOS) path, a non-line-of-sight (NLOS) path, user equipment (UE) location information, a number of detected paths, or a combination thereof; and
output a response message comprising the labelled set of positioning measurements to the AI training system based at least in part on the received request message from the location server, the response message indicating deployment and training of an AI model using the labelled set of positioning measurements.

22. The processor of claim 21, wherein, to label the collected set of positioning measurements, the at least one controller is configured to cause the processor to:
label the collected set of positioning measurements by associating each of one or more positioning measurements of the collected set of positioning measurements based on a received label indication.

23. The processor of claim 21, wherein, to output the labelled set of positioning measurements, the at least one controller is configured to cause the processor to:
transmit, to the location server, the response message comprising the labelled set of positioning measurements, the location server comprising the AI training system, wherein the response message comprising an indication signaling to the location server to deploy the AI model at the location server.

24. The apparatus of claim 1, wherein the at least one processor is further configured to cause the apparatus to label the each of the one or more positioning measurements with a timestamp.
